(19) United States
(12) Patent Application Publication
(10) Pub. No.: US 2017/0206372 A1
(43) Pub. Date: Jul. 20, 2017

(54) DATA MANAGEMENT SYSTEM, DATA MANAGEMENT METHOD, AND RECORDING MEDIUM

(71) Applicant: NEC CORPORATION, Tokyo (JP)

(72) Inventor: Dongki JUNG, Tokyo (JP)

(73) Assignee: NEC CORPORATION, Tokyo (JP)

(21) Appl. No.: 15/401,699

(22) Filed: Jan. 9, 2017

(30) Foreign Application Priority Data
Jan. 18, 2016 (JP) 2016-006791

(51) Int. Cl. G06F 21/62; G06F 17/30; H04L 29/06; H04L 9/14; G06F 21/72; H04L 9/08

(52) U.S. Cl. CPC G06F 21/6218; G06F 21/72; H04L 9/0891; H04L 9/0861; H04L 63/0807; H04L 63/166; H04L 63/0428; H04L 9/0894; H04L 9/14; G06F 17/30864

(57) ABSTRACT

Provided is a data management system that is configured to divide a table in a database into one or more partitions based on data included in a particular column included in the table, associate an encryption key with each partition of the partitions and store the encryption key in the memory, and execute cryptographic processing for data included in the partition by the encryption key being associated with the partition.

This application is based upon and claims the benefit of priority from Japanese Patent Application No. 2016-006791, filed on Jan. 18, 2016, the disclosure of which is incorporated herein in its entirety by reference.

### TECHNICAL FIELD

The present disclosure relates to a data management system capable of protecting data, and the like.

### BACKGROUND ART

Data management systems, such as data base and the like, is widely used recently. As the data managed (stored) in such a system become more important, protection of data becomes also important. In relation to protection of data, following technologies have been known.

Patent Literature 1 (Japanese Patent Laid-Open No. 2011-164907) discloses a technology for separating an information management server that manages information from a cryptographic processing server that executes cryptographic processing with regard to the information, in order to reduce the risk of leakage of both of encrypted information and an encryption key.

Patent Literature 2 (Japanese Patent Laid-Open No. 2011-048661) discloses a technology for a system in which plural virtual servers are operated.

With regard to the technology of patent Literature 2, the system encrypts data of guest OSes by using encryption keys different for each guest OSes, which are virtual operating systems (OSes) used by users.

Patent Literature 3 (Japanese Patent Laid-Open No. 2010-148022) discloses an encryption key management system which manages a destination of information and an encryption key for encrypting the information by associating them with each other. The encryption key management system described in Patent Literature 3 encrypts an encryption key which is associated with the destination by a master key, and sends out the encryption key to each destination. As a result, the encryption key management system distributes different encryption key according to respective business system.

Patent Literature 4 (Japanese Patent Laid-Open No. 2011-019129) discloses a data management system that implements access control for a secondary user who uses data that has been entrusted (entrusted data), depending on the policy of a party who has entrusted the data. The data management system manages the entrusted data by encrypting them with use of a first encryption key. The data management system re-encrypts the data using a second encryption key according the policy, and provides the data being encrypted by the second encryption key, to the secondary user.

Patent Literature 5 (Japanese Patent Laid-Open No. 2004-254271) discloses network apparatuses that forms groups by apparatuses selected by a user and execute encrypted communication in the groups in a home network. The network apparatuses communicate with each other by using a different encryption key for each of the formed groups, thereby eliminate communication from the apparatuses other than the group.

Patent Literature 6 (Japanese Patent Laid-Open No. 2001-265771) discloses a technology for storing personal information in a personal information management center by dividing the personal information into pieces of information (partial personal information) that cannot identify a particular person alone, and for managing relations between the pieces of partial personal information in a personal information provider terminal.

Patent Literature 7 (International Publication No. WO 2004/036350) discloses a technology for providing a security file system layer implementing access control functionality between an OS kernel and a file system. In the technology disclosed in Patent Literature 7, an access controller independent of the OS controls file access in the security file system layer, and executes transparent cryptographic processing of files.

Patent Literature 8 (U.S. Patent Application No. 2007/0294539) discloses a technology for encrypting confidential information included in a database manipulation language, thereby transparently encrypting confidential information stored in a database. In the technology disclosed in Patent Literature 8, a cryptographic processing gateway that is arranged between a client and a DB server encrypts confidential information accepted from the client, and stores the encrypted confidential information in the DB server. The cryptographic processing gateway decrypts the confidential information stored in the DB server in response to a request from the client, and sends the decrypted confidential information to the client.

### SUMMARY

An exemplary object of the present disclosure is to provide a data management system and the like that is able to perform cryptographic processing respectively with regard to one or more partial areas that are acquired by dividing a database into an appropriate granularity.

To achieve aforementioned objective, a data management system with regard to one aspect of the present disclosure is, for example, configured as follows. That is, the data management system with regard to one aspect of the present disclosure is configured to divide a table in a database into one or more partitions based on data included in a particular column included in the table, associate an encryption key with each partition of the partitions and store the encryption key in the memory, and execute cryptographic processing for data included in the partition by the encryption key being associated with the partition.

A data management method with regard to another aspect of the present disclosure includes dividing a table in a database into one or more partitions based on data included in a particular column included in the table; and executing cryptographic processing for data included in the partitions using encryption keys associated with the respective partitions.

The object is also achieved by a computer program that is able to implement, by use of a computer, the data management system or the data management method configured as described above, and a computer-readable storage medium in which the computer program is stored, and the like.

### BRIEF DESCRIPTION OF THE DRAWINGS

Exemplary features and advantages of the present invention will become apparent from the following detailed description when taken with the accompanying drawings in which:

FIG. 1 is an explanatory diagram representing a specific example of a key-value store (KVS) and its division into partition;

FIG. 2 is a block diagram illustrating the functional configuration of a data management system in a first example embodiment of the present disclosure;

FIG. 3 is a block diagram illustrating the functional configuration of components included in the data management system in the first example embodiment of the present disclosure;

FIG. 4 is an explanatory diagram illustrating a specific example of a configuration for managing cached encryption keys in the first example embodiment of the present disclosure;

FIG. 5 is an explanatory diagram illustrating a specific example of a configuration for managing encryption keys in the first example embodiment of the present disclosure;

FIG. 6 is an explanatory diagram for explaining an overview of authentication processing in the first example embodiment of the present disclosure;

FIG. 7 is a sequence diagram illustrating a process of authentication in the first example embodiment of the present disclosure;

FIG. 8 is an explanatory diagram illustrating an overview of data acquisition (“GET”) processing in the first example embodiment of the present disclosure;

FIG. 9A is a sequence diagram illustrating a process (1) of acquiring data (“GET” processing) in the first example embodiment of the present disclosure;

FIG. 9B is a sequence diagram illustrating a process (2) of acquiring data (“GET” processing) in the first example embodiment of the present disclosure;

FIG. 9C is a sequence diagram illustrating a process (3) of acquiring data (“GET” processing) in the first example embodiment of the present disclosure;

FIG. 10 is a flowchart illustrating processing for managing the effective period of a cached encryption key in the first example embodiment of the present disclosure;

FIG. 11 is an explanatory diagram illustrating an overview of processing of storing data (“PUT” processing) in the first example embodiment of the present disclosure;

FIG. 12 is a sequence diagram illustrating a process of storing data (“PUT” processing) in the first example embodiment of the present disclosure;

FIG. 13 is an explanatory diagram illustrating an overview of processing of updating encryption keys in the first example embodiment of the present disclosure;

FIG. 14 is a sequence diagram illustrating a process of updating the encryption keys in the first example embodiment of the present disclosure;

FIG. 15 is a block diagram illustrating the functional configuration of a data management system in a second example embodiment of the present disclosure;

FIG. 16 is an explanatory diagram illustrating the configuration of a data set stored in the data management system in the second example embodiment of the present disclosure;

FIG. 17 is an explanatory diagram illustrating a specific example of a configuration for managing encryption keys in the second example embodiment of the present disclosure;

FIG. 18 is an explanatory diagram illustrating a specific example of a configuration for managing cached encryption keys in the second example embodiment of the present disclosure;

FIG. 19A is a block diagram illustrating the functional configuration of a data management system in a third example embodiment of the present disclosure;

FIG. 19B is a block diagram illustrating the another functional configuration of the data management system in the third example embodiment of the present disclosure;

FIG. 20A is an explanatory diagram illustrating a specific example of the configuration of a data set stored in the data management system in the third example embodiment of the present disclosure;

FIG. 20B is an explanatory diagram illustrating another specific example of the configuration of a data set stored in the data management system in a third example embodiment of the present disclosure;

FIG. 21 is an explanatory diagram illustrating a specific example of a database provided by the data management system in the third example embodiment of the present disclosure;

FIG. 22 is an explanatory diagram illustrating information representing the schema of a database provided by the data management system in the third example embodiment of the present disclosure;

FIG. 23A is an explanatory diagram illustrating a specific example of a data set stored in the data management system in the third example embodiment of the present disclosure;

FIG. 23B is an explanatory diagram illustrating another specific example of a data set stored in the data management system in the third example embodiment of the present disclosure;

FIG. 24 is an explanatory diagram illustrating a specific example of a query described in SQL;

FIG. 25 is an explanatory diagram illustrating another specific example of a query described in SQL;

FIG. 26 is a block diagram illustrating the functional configuration of a data management system in an alternative example of the third example embodiment of the present disclosure;

FIG. 27 is an explanatory diagram illustrating information representing a schema in a case where an encryption level is set for each column of a database, in the alternative example of the third example embodiment of the present disclosure;

FIG. 28 is an explanatory diagram illustrating information representing a schema in a case where an encryption level is set for each of partitions into which the database is divided, in the alternative example of the third example embodiment of the present disclosure;

FIG. 29 is a block diagram illustrating the functional configuration of a data management system 4 in a fourth example embodiment of the present disclosure;

FIG. 30 is an explanatory diagram illustrating the configuration of partitions into which a KVS is re-divided;

FIG. 31 is an explanatory diagram illustrating a specific example of associations of partitions, into which a KVS is re-divided, with encryption keys;

FIG. 32 is a block diagram illustrating the functional configuration of a data management system in a fifth example embodiment of the present disclosure;

FIG. 33 is a block diagram illustrating the functional configuration of a data management system in a sixth example embodiment of the present disclosure; and

FIG. 34 is a view illustrating the hardware configuration of an information processing apparatus capable of actualizing each example embodiment of the present disclosure.

### EXAMPLE EMBODIMENT

Possible example embodiments of the present disclosure will be described in detail below with reference to the drawings. Configurations described in the example embodiments below are presented as examples, and the technical scope of the present disclosure is not limited to the configurations.

A data management system described in each example embodiment below may be implemented using a single apparatus (physical or virtual apparatus). Such a data management system may be implemented using plural apparatuses (physical or virtual information processing apparatuses and the like). In this case, each component included in the data management system may be implemented using one or more apparatuses. One or more components included in such a data management system may be implemented using one apparatus. Components included in such a data management system may be arranged to respective apparatus appropriately. One or more apparatuses included in such a data management system may be communicatively connected via a wired or wireless communication network or a communication network (communication line) in which such wired and wireless communication networks are combined appropriately. Such a communication network may be realized by a physical communication network or a virtual communication network.

### First Example Embodiment

A first example embodiment of the present disclosure will be specifically described with reference to the drawings.

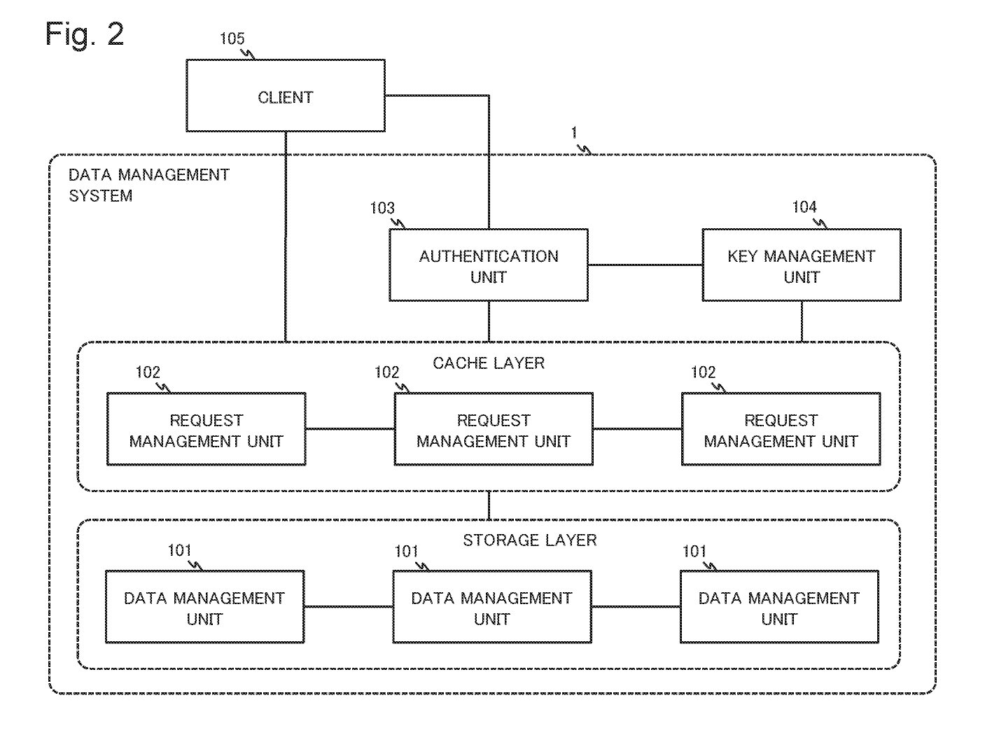

In the present example embodiment, a configuration in which a data management system 1 (FIG. 2) manages data by using a data store realized by a key-value store (hereinafter simply referred to as “KVS”) is described as an example. In this case, the data management system 1 constructs a database using the KVS. However, the following description is not intended to limit the data management system 1 in the present example embodiment. The data management system 1 may manage data by using another data store (for example, data store realized by relational database (RDB)).

First, an overview of a data management method in the data management system 1 will be described.

The data management system 1 manages data stored in the data management system 1 using the KVS, as described above. The KVS is a data management system that is able to store a pair of data (VALUE) and a KEY which are associated with each other. The KEY represents identification information that is used to identify the data (VALUE). Hereinafter, a KEY may be referred to as “first data”. Data associated with the KEY may be referred to as “second data” or “VALUE”. A pair of a KEY and a VALUE may be referred to as “data set”. The KVS can be conceptually represented using, for example, a table including a column of a KEY and a column of a VALUE. Such a KVS can also be conceptually represented using, for example, an associative array (map) in which a KEY and data are associated with each other. A data structure that conceptually represents a KVS is not limited to the above but may be selected appropriately.

Hereinafter, operation of storing (registering) a particular data set in a KVS is referred to as “PUT” (or “PUT” processing). Operation of specifying a particular KEY and acquiring a VALUE associated with the KEY is referred to as “GET” (or “‘GET’ processing”). For example, when a KVS is configured by using a table, the “GET” processing corresponds to operation of specifying a KEY arranged in column and acquiring a data set registered in the table. The “PUT” processing corresponds to operation of registering the data set in the table. For example, when a KVS is configured by using an associative array, the “GET” processing corresponds to operation of specifying a particular KEY and acquiring a data set registered in the associative array. The “PUT” processing corresponds to operation of registering the data set in the associative array.

The data management system 1 manages a KVS, in which data sets are stored, by dividing the KVS into plural partial areas including one or more data sets. Hereinafter, such a partial area is referred to as “partition”. In this case, the KVS managed by the data management system 1 includes plural partitions, and one or more data sets are assigned to each of the partitions.

Specifically, the data management system 1 divides the KVS into the plural partitions based on the KEYs of the data sets stored in the KVS (specifically, for example, value calculated from the KEY). On the basis of the KEY of a particular data set, the data management system 1 assigns the data set to a particular partition. For example, when a KVS is represented using a table, the data management system 1 may divide the table representing the KVS into plural partitions based on data (KEY) (or value calculated from the data (KEY)) included in a particular column (in this case, key column). For example, when a KVS is represented using an associative array, the data management system 1 may divide the associative array into plural portions according to the value of a KEY (or value calculated from KEY).

The data management system 1 may adopt, for example, a consistent hashing method as a method for creating such partitions (for example, refer to the following Reference Literature 1). The data management system 1 may adopt another appropriate partitioning method without being limited to the above. For example, as another partitioning method, a method of dividing the KVS into partitions according to ranges of KEY values in the KVS may be used. For example, as yet another partitioning method, a method of dividing the KVS into partitions based on whether or not KEY values in the KVS are included in a set of particular values (for example, list of predetermined region names, customer names, and the like) may be used. Further, as yet another partitioning method, a method of dividing the KVS into partitions, based on hash values calculated from KEY values by use of a method other than consistent hashing may be used.

### Reference Literature 1

Giuseppe DeCandia, Deniz Hastorun, Madan Jampani, Gunavardhan Kakulapati, Avinash Lakshman, Alex Pilchin, Swaminathan Sivasubramanian, Peter Vos shall, and Werner Vogels, “Dynamo: Amazon's Highly Available Key-value Store”, Proceeding SOSP ‘07 Proceedings of twenty-first ACM SIGOPS symposium on Operating systems principles, Oct. 14, 2007, p.p. 205-220.

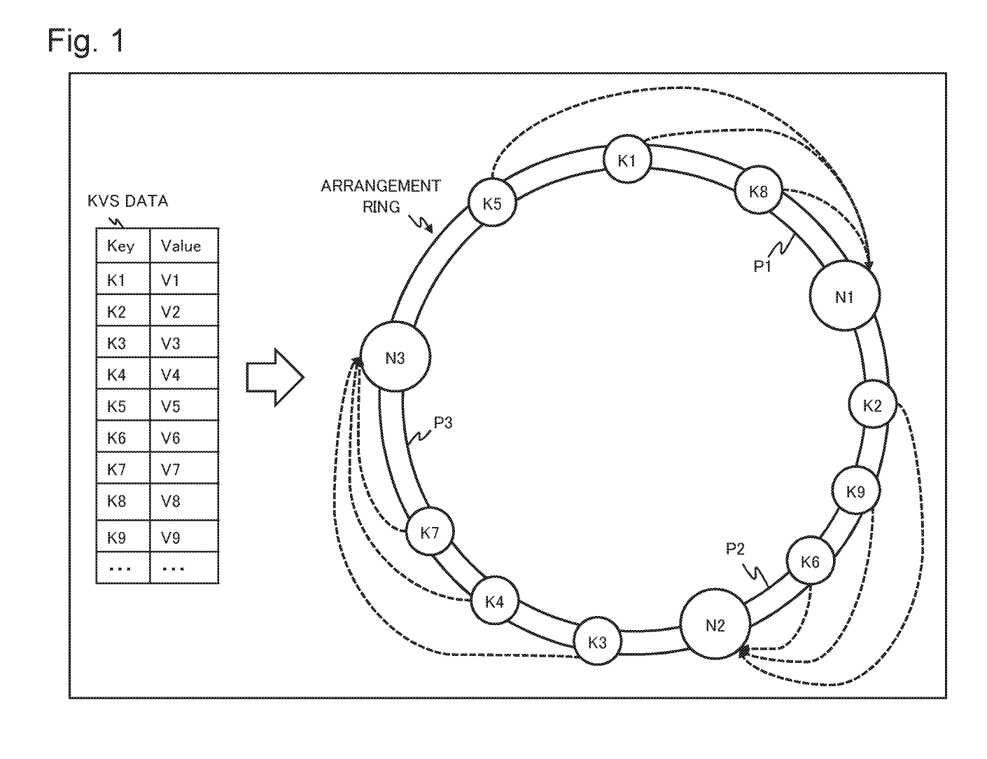

In the present example embodiment, it is assumed that the data management system 1 configures (creates) partitions using a consistent hashing method. An overview of such a partition configuration will be described below. FIG. 1 is an explanatory diagram conceptually illustrating a specific example of a KVS and the partition configuration thereof. FIG. 1 is one specific example for convenience of explanation, and the present example embodiment is not limited thereto.

The data management system 1 treats the output of a particular hash function “H” as an annular (ring-shaped) arrangement space (corresponding to “arrangement ring” in FIG. 1). In such an arrangement space, the maximum value of the hash function “H” and the minimum value of the hash function “H” are arranged so as to be adjacent to each other.

The data management system 1 arranges nodes (for example, “N1” to “N3” illustrated in FIG. 1) on the arrangement ring. Such nodes are implemented by, for example, a physical or virtual information processing apparatus which can store data.

The data management system 1 calculates hash values with regard to the KEYs of data sets stored in a KVS (for example, “KVS data” illustrated in FIG. 1) using the hash function “H”. The data management system 1 arranges the KEYs in positions corresponding to the calculated hash values in the arrangement ring.

The data management system 1 assigns a data set including a KEY to a node arranged in the position being clockwise nearest, in the arrangement ring, based on the KEY arranged in the arrangement ring. In other words, a KEY that is arranged between a particular node (for example, “N3” in FIG. 1) and another node (for example, “N1” in FIG. 1) that is clockwise adjacent to the particular node on the arrangement ring is assigned to the adjacent (another) node. In the specific example illustrated in FIG. 1, KEYs “K5”, “K1”, and “K8” are assigned to a node “N1”. KEYs“K2”, “K9”, and “K6” are assigned to a node “N2”. KEYs “K3”, “K4”, and “K7” are assigned to a node “N3”. The data management system 1 treats an area between nodes adjacent to each other as one partition (“P1” to “P3” illustrated in FIG. 1), and assigns each partition to the node. As a result, the KVS is divided into the one or more partitions and partitions are assigned to the nodes. Therefore, a load caused by management of data is distributed among the nodes.

For example, the data management system 1 may arrange each node in the arrangement ring so that, for example, the number (or size) of data sets included in a partition assigned to each node is equal (or substantially equal). For another example, the data management system 1 may randomly arrange one or more nodes in the arrangement ring. For yet another example, the data management system 1 may calculate, by use of a hash function “H”, a hash value that represents identification information being able to identify a node, and arrange the node in a position corresponding to the calculated hash value in the arrangement ring.

In the above description, one partition is assigned to one substantial node. However, the present example embodiment is not limited thereto. For example, a virtual node that is able to manage one partition may be introduced. In this case, a plurality of virtual nodes may be implemented by one substantial node. As a result, one substantial node can substantially manage plural partitions.

The data management system 1 encrypts data sets stored in the KVS using, for example, one or more pieces of information (for example, encryption keys and the like) that are individually set for each partition and used in cryptographic processing. Further, the data management system 1 provides transparent cryptographic processing to a client accessing data stored in the KVS. In other words, the client using the data management system 1 can request access to the data stored in the KVS without considering details of the cryptographic processing.

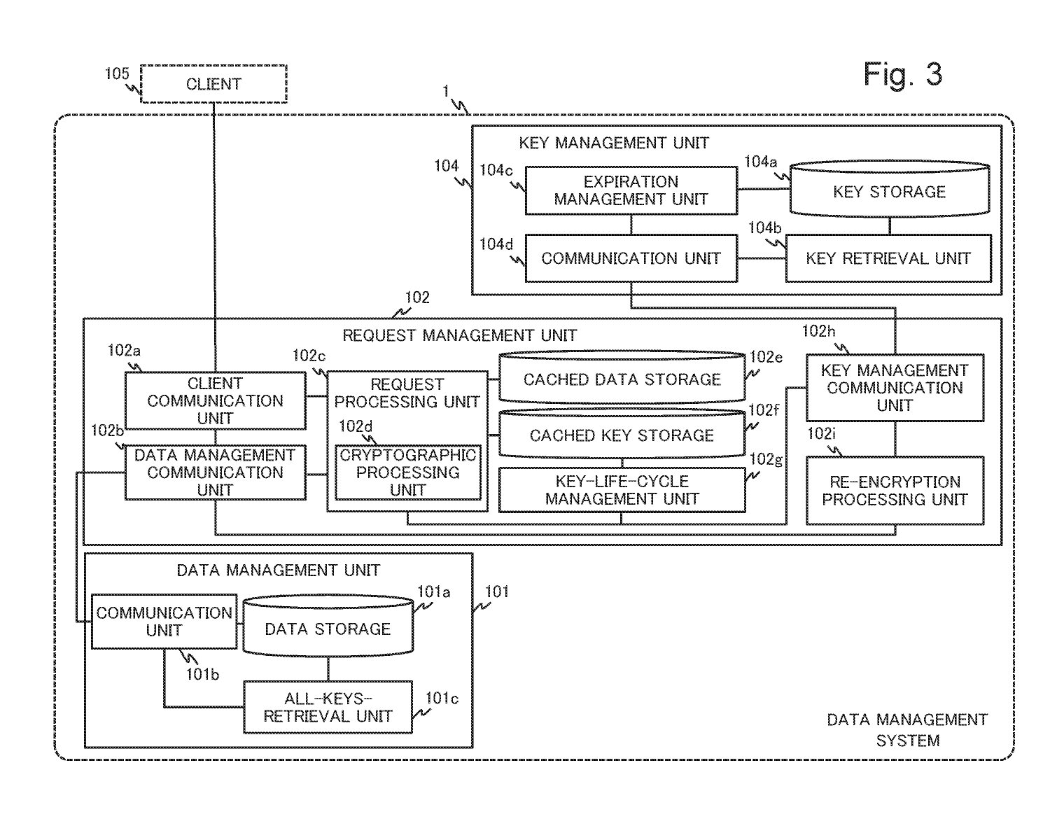

A specific configuration that can implement the data management system 1 will be described below with reference to FIG. 2 and FIG. 3. FIG. 2 and FIG. 3 are block diagrams illustrating the functional configuration of the data management system 1 in the present example embodiment. The configuration illustrated in FIG. 2 and FIG. 3 is one specific example of a functional configuration that can implement the data management system 1, and the present example embodiment is not limited thereto. In functional components illustrated in FIG. 2, and FIG. 3, one or more components may be merged, or each component may be further divided. Arrangement of each component may be changed appropriately as long as similar functionalities can be realized.

As illustrated in FIG. 2, the data management system 1 in the present example embodiment includes at least one or more data management units 101, at least one or more request management units 102, and a key management unit 104. The data management system 1 may include plural data management units 101 and may include plural request management units 102. The data management system 1 may include an authentication unit 103. The data management system 1 in the present example embodiment is connected communicatively to a client 105 via an appropriate communication network. For example, such a communication network may be a wide area network such as the Internet, may be a narrow area network such as a local area network, or may be a combination thereof. Such a communication network may be realized by use of wired communication, wireless communication, or an appropriate combination thereof.

The data management unit 101 stores data in the KVS managed by the data management system 1, and processes access to the data. The data management unit 101 can store persistent data. The data management unit 101 can also store encrypted data. Hereinafter, such a data management unit 101 may be referred to as “KVS apparatus”. Such a data management unit 101 can be implemented using one or more appropriate number of virtual or physical information processing apparatuses. A data storage 101a (described later) in the data management unit 101 can be implemented using, for example, a known virtual storage technology.

For example, the data management unit 101 can implement such nodes as described above, to manage one or more partitions included in the KVS. The data management unit 101 processes access to each data set included in the partitions. The data management unit 101 may implement the nodes described above, along with the request management unit 102 (described later).

As illustrated in FIG. 3, the data management unit 101 includes the data storage 101a, a communication unit 101b, and an all-keys-retrieval unit 101c. These components included in the data management unit 101 are communicatively connected using an appropriate communication method (communication bus, communication network, and the like).

The data storage 101a (KVS storage unit) provides a data store realized by a KVS, and one or more partitions included in the KVS are stored in the data storage 101a. In other words, the data storage 101a is able to store data sets assigned to (included in) the partitions included in the KVS. The data storage 101a may store the partitions by using an appropriate data storing method (for example, file, database, or the like).

The data storage 101a is configured to store encrypted data sets as described later. In the present example embodiment, it is assumed that data sets including encrypted VALUEs are stored in the data storage 101a.

The communication unit 101b processes communication with the request management unit 102 (described later). For example, the communication unit 101b receives an access request to a particular data set, which has been sent from the request management unit 102, and sends the processing result of the access request. The communication unit 101b may execute communication processing other than the above.

For each partition managed by the data management unit 101, the all-keys-retrieval unit 101c retrieves the KEYs of all data sets included in the partition. The all-keys-retrieval unit 101c can scan the KEYs of all the data sets included in the partitions managed by the data management unit 101, and can acquire the results of the scanning.

In the present example embodiment, any data management unit 101 may control arrangement of the nodes (for example, each data management unit 101) in the arrangement ring described above, and division of the partitions. Information about the arrangement of the nodes and the division of the partitions can be shared among the plural data management units 101. That information also may be shared among the plural request management units 102.

An overview of the request management unit 102 in the present example embodiment will be described below. The request management unit 102 accepts an access request (“GET” request, “PUT” request) to data stored in the KVS from the client 105, and process the access request. The request management unit 102 may be configured to implement the node described above, along with the data management unit 101. The request management unit can be implemented using one or more appropriate number of virtual or physical information processing apparatuses.

In the request management unit 102, hot data (frequently referenced data, recently referenced data, and the like) can be stored as a cache. As a result, when data requested by the client 105 is stored in the cache, the request management unit 102 can provide the data stored in the cache to the client without requesting the data from the data management unit 101. Further, the request management unit 102 provides transparent cryptographic processing to the client 105. A specific configuration example of the request management unit 102 will be described below.

The request management unit 102 includes a client communication unit 102a, a data management communication unit 102b, and a key management communication unit 102h, as illustrated in FIG. 3. The request management unit 102 includes a request processing unit 102c, a cryptographic processing unit 102d, a cached data storage 102e, a cached key storage 102f, and a key-life-cycle management unit 102g. The request management unit 102 includes a re-encryption processing unit 102i. These components included in the request management unit 102 are communicatively connected using an appropriate communication method (communication bus, communication network, or the like).

The client communication unit 102a is connected communicatively to the client 105, and executes communication processing with the client 105. Specifically, the client communication unit 102a receives, from the client 105, an access request to the data sets stored in the KVS. The client communication unit 102a supplies the received access request to the request processing unit 102c.

The data management communication unit 102b is connected communicatively to the data management unit 101 (for example, communication unit 101b). The data management communication unit 102b sends an access request to the data management unit 101 according to a direction from the request processing unit 102c, and receives the result of processing of the access request. The data management communication unit 102b may establish a secure communication channel, between the data management communication unit 102b and the data management unit 101 to which the data management communication unit 102b is connected. The data management communication unit 102b may establish such a secure communication channel using, for example, an encryption communication protocol such as, secure socket layer (SSL) or transport layer security (TLS).

The request processing unit 102c processes the access request received from the client communication unit 102a. The request processing unit 102c executes cryptographic processing of data sets targeted for the access request using the cryptographic processing unit 102d (described later), as needed. Specifically, the request processing unit 102c acquires, from the data management unit 101, a VALUE associated with a KEY specified in a request for “GET” processing (“GET” request) received from the client, and decrypts the VALUE. Further, the request processing unit 102c encrypts a VALUE specified in a request for “PUT” processing (“PUT” request) received from the client. The request processing unit 102c requests the key management communication unit 102h (described later) to acquire an encryption key, as needed, and stores (saves) the acquired encryption key in the cached key storage 102f.

The cryptographic processing unit 102d executes the above-described cryptographic processing in the request processing unit 102c. The cryptographic processing unit 102d is able to execute encryption processing with regard to at least part of the data sets stored in the KVS. The cryptographic processing unit 102d also is able to decrypt the encrypted data sets stored in the KVS. The cryptographic processing unit 102d executes the cryptographic processing using secret information (encryption key and the like) that is set for each partition and used in the cryptographic processing. For convenience in description, it is assumed below that secret information used in such cryptographic processing includes an encryption key. In some embodiment, such secret information may include data other than an encryption key. The cryptographic processing unit 102d may execute cryptographic processing using a standardized encryption algorithm. For example, Advanced Encryption Standard (AES), Triple Data Encryption Standard (triple-DES), or the like can be adopted as such an encryption algorithm, as appropriate.

The cached data storage 102e is configured to store hot data at least temporarily (for example, frequently accessed data set, most recently accessed data set, and the like). As a result, the cached data storage 102e can provide a cache with regard to the KVS managed by the data management unit 101. The cached data storage 102e may be implemented using a virtual or physical storage area. The cached data storage 102e is able to store an encrypted data set and a plaintext data.

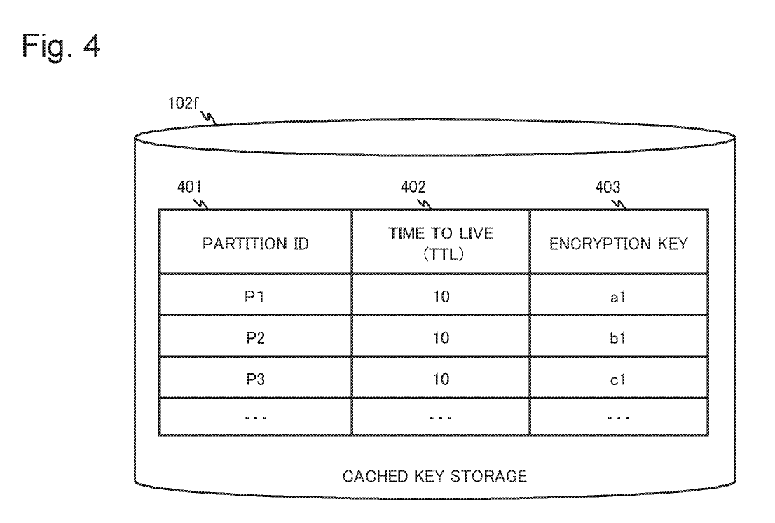

The cached key storage 102f is configured to store, at least temporarily, an encryption key used in the cryptographic processing in the cryptographic processing unit 102d. As a result, the cached key storage 102f is able to provide a cache relating to the encryption key managed by the key management unit 104. Specifically, as illustrated in FIG. 4, the cached key storage 102f stores information for specifying a partition (partition ID (Identifier), 401 in FIG. 4) and an encryption key (403 in FIG. 4) that is assigned to the partition, by associating them with each other. An effective period (time-to-live (TTL), 402 in FIG. 4) for an encryption key may be also stored in the cached key storage 102f. The unit of TTL may be set as appropriate (for example, “second”, “minute”, “hour”, and the like). The cached key storage 102f may store data other than the above by associating the data with the partition ID 401.

The key-life-cycle management unit 102g manages the life cycles of encryption keys stored in the cached key storage 102f. Specifically, the key-life-cycle management unit 102g checks the TTL of the encryption keys stored in the cached key storage 102f, and executes appropriate processing with regard to the encryption key of which TTL is expired. When an encryption key associated with a particular partition in the key management unit 104 is updated, the key-life-cycle management unit 102g may delete the encryption key before the updating.

The key management communication unit 102h is connected communicatively to the key management unit 104 (for example, communication unit 104d), and sends and receives an encryption key used in the cryptographic processing in the cryptographic processing unit 102d. The key management communication unit 102h accepts a notice of the updating of the encryption key associated with each partition, from the key management unit 104. The key management communication unit 102h may notify updating of the encryption key to the re-encryption processing unit 102i (described later). The key management communication unit 102h may notify updating of the encryption key to the key-life-cycle management unit 102g. The key management communication unit 102h executes various communications using a secure communication channel, between the key management communication unit 102h and the key management unit 104 (described later).

On the basis of the notification of the updating of an encryption key associated with a particular partition, the re-encryption processing unit 102i executes re-encryption processing for a data set included in the partition. Such re-encryption processing includes, for example, processing of decoding a data set included in a partition in which the encryption key has been updated with the use of the encryption key before the updating, and processing of re-encrypting the data set using the updated encryption key.

The client communication unit 102a, the data management communication unit 102b, and the key management communication unit 102h described above may be implemented using a common communication device, or may be implemented using plural communication devices. Such a communication device may be, for example, a physical or virtual communication interface (for example, network interface card), or the like.

The cached data storage 102e and the cached key storage 102f described above may be implemented using a common storage device, or may be implemented using different storage devices. Such a storage device may be, for example, a physical or virtual storage device (for example, random access memory (RAM) or the like).

In the present example embodiment, a virtual cache layer may be formed by integrating plural request management units 102.

The key management unit 104 manages encryption keys used in the cryptographic processing for the data sets stored in the KVS. As described above, such an encryption key is an encryption key used in processing of encrypting or decoding a data set. The key management unit 104 is connected communicatively to the one or more request management units 102.

The key management unit 104 includes a key storage 104a, a key retrieval unit 104b, an expiration management unit 104c, and a communication unit 104d, as illustrated in FIG. 3. These components included in the key management unit 104 are communicatively connected using an appropriate communication method.

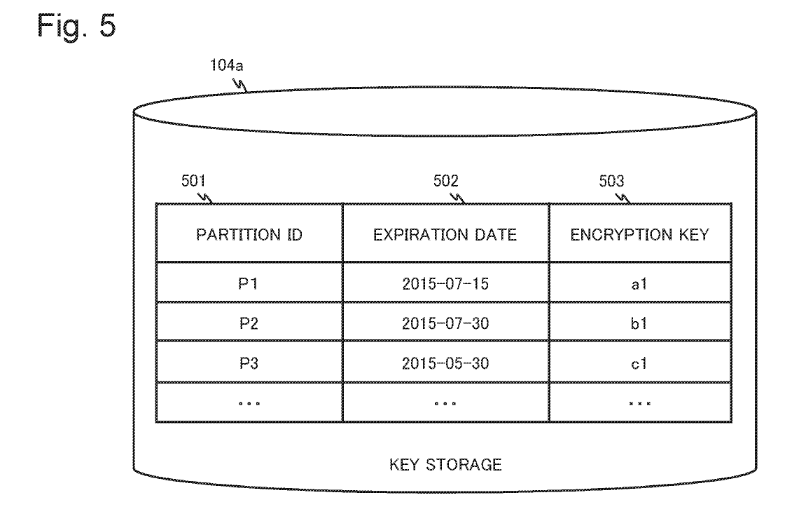

The key storage 104a associates an encryption key used in cryptographic processing for a data set included in a partition to the partition included in the KVS, and stores the encryption key. The key storage 104a may store, information (for example, partition ID (501 in FIG. 5)) for specifying a partition included in the KVS, an encryption key (503 in FIG. 5), and information (expiration date 502 in FIG. 5) representing the expiration date of the encryption key by associating them with each other, as illustrated in FIG. 5. In the key storage 104a, data other than the above may be associated with the partition ID 501, and may be stored.

The initial value of an encryption key associated with each partition may be set in advance, or may be generated appropriately by the key management unit 104 when the partition is created. Similarly, the expiration date of the encryption key of each partition may be set in advance, or may be set as appropriate by the key management unit 104 when the partition is created. Different values may be set as the initial values of the expiration date for each encryption keys with regard to each partition. In this case, timing for executing re-encryption processing (described later) varies according to each partition, and therefore, the key management unit 104 can distribute a processing load caused by the re-encryption.

When a KEY of a particular data set is given, the key retrieval unit 104b specifies a partition including the KEY. The key retrieval unit 104b acquires an encryption key associated with the partition ID of the specified partition from the key storage 104a. Specifically, for example, the key retrieval unit 104b may calculate the hash value of the given KEY to specify the partition including the data set including the KEY based on the calculated hash value.

The expiration management unit 104c manages the expiration date of the encryption key of each partition stored in the key storage 104a. After the expiration date of an encryption key associated with a particular partition, the expiration management unit 104c updates the encryption key. The expiration management unit 104c sets a new expiration date to the updated encryption key. For example, the expiration management unit 104c sets a new encryption key and the expiration date of the encryption key to the key storage 104a. The expiration management unit 104c may set different the expiration dates to respective encryption key. As a result, re-encryption processing (described later) is executed at different timing depending on the partitions, and therefore, the key management unit 104 can distribute a processing load caused by the re-encryption.

The expiration management unit 104c notifies the request management unit 102 of information about the updating of the encryption keys. The expiration management unit 104c notifies the request management unit 102 of, for example, information (for example, partition ID) for specifying a partition in which the encryption key has been updated, the encryption key before the updating, and the encryption key after the updating.

The communication unit 104d executes communication processing with the request management unit 102 (for example, key management communication unit 102h). The communication unit 104d establishes a secure communication channel with the request management unit 102 in order to prevent leakage of an encryption key. Specifically, the communication unit 104d may send, for example, data encrypted by a public key issued by the request management unit 102 to the request management unit 102. Without limitation to the above, the communication unit 104d may use a well-known public key infrastructure (PKI) technology to authenticate the legitimacy of the request management unit 102 or to encrypt a communication channel for the request management unit 102. For example, the communication unit 104d may adopt an encrypted communication protocol such as SSL or TLS in order to establish a secure communication channel.

The authentication unit 103 processes an authentication request from the client 105. In response to the authentication request from the client 105, the authentication unit 103 confirms whether or not the client 105 has a qualification for connecting to the request management unit 102. The authentication unit 103 permits a client having a proper qualification for connecting to the request management unit 102, based on the result of the authentication processing. Specifically, the authentication unit 103 issues a ticket used when connecting to the request management unit 102. The authentication processing between the authentication unit 103 and the client 105 may be realized using, for example, an authentication technology such as, Kerberos authentication and the like.

The client 105 is, for example, an information communication apparatus such as a computer that requests access to data stored in the data management system 1.

The operation of the data management system 1 in the present example embodiment configured as described above will be described below with reference to the drawings.

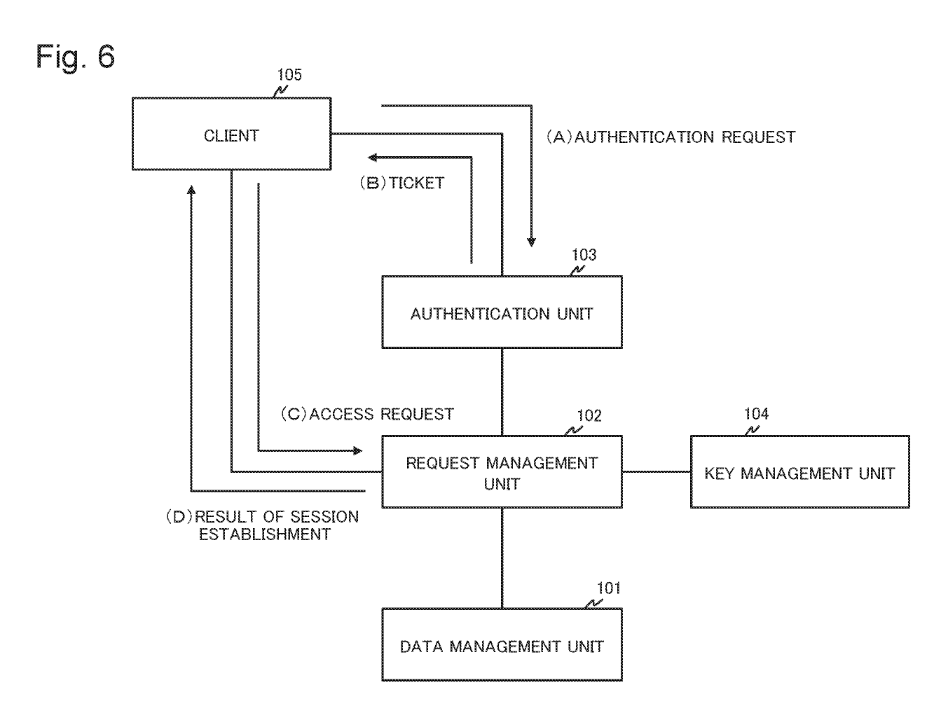

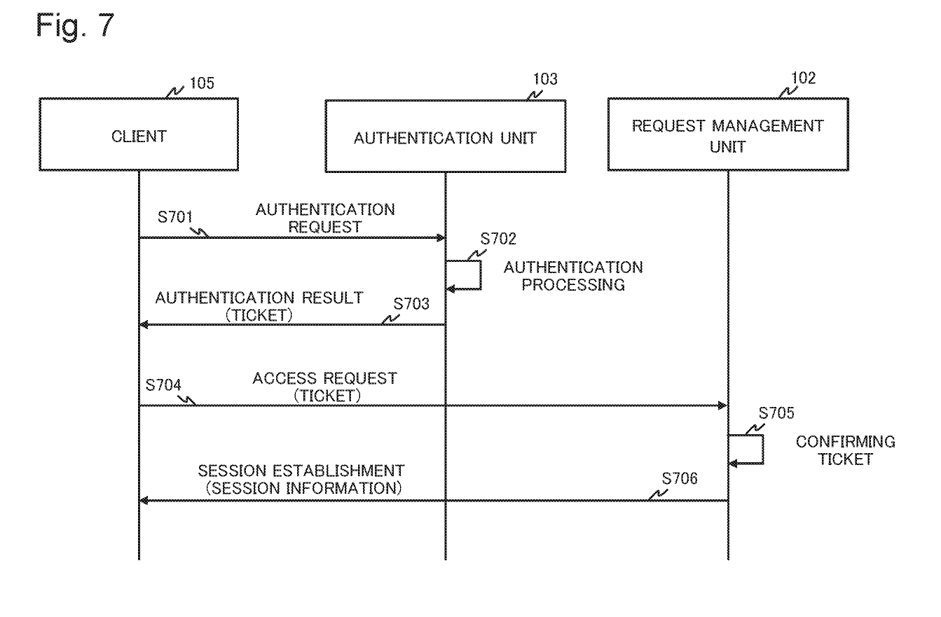

First, authentication processing for the client 105 is described with reference to FIG. 6 and FIG. 7. FIG. 6 is an explanatory diagram representing an overview of processing for the client 105 to connect to the request management unit 102, and FIG. 7 is a sequence diagram representing the processing.

As illustrated in FIG. 6, the client 105 sends an authentication request to the authentication unit 103 ((“A”) in FIG. 6), and receives a ticket as an authentication result ((“B”) in FIG. 6). The client 105 uses the ticket to send an access request to the request management unit 102 ((“C”) in FIG. 6) and to receive a session establishment result ((“D”) in FIG. 6).

More specifically, the client 105 sends, for example, an authentication request including the authentication password of the client 105 itself to the authentication unit 103 (step S701).

The authentication unit 103 executes authentication processing (step S702 in FIG. 7). Specifically, the authentication unit 103 determines whether or not a password received from the client 105 is correct. When the password is correct, the authentication unit 103 issues, to the client 105, authentication information (for example, a ticket) used for connecting to the request management unit (step S703 in FIG. 7).

The client 105 sends the issued ticket to the request management unit 102. The client 105 requests connection (access) to the request management unit 102, for example, by this procedure (step S704).

The request management unit 102 checks the received ticket (step S705), and permits connection from the client 105 to establish a communication session when the ticket is a legitimate ticket (step S706). The request management unit 102 may send session information to the client 105.

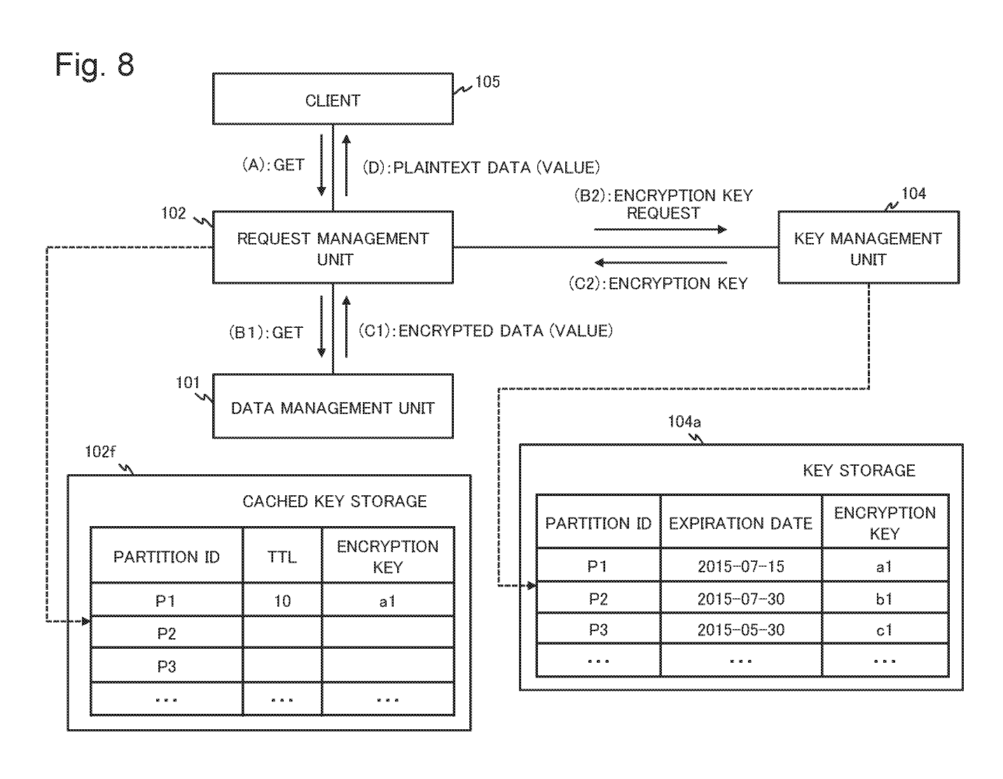

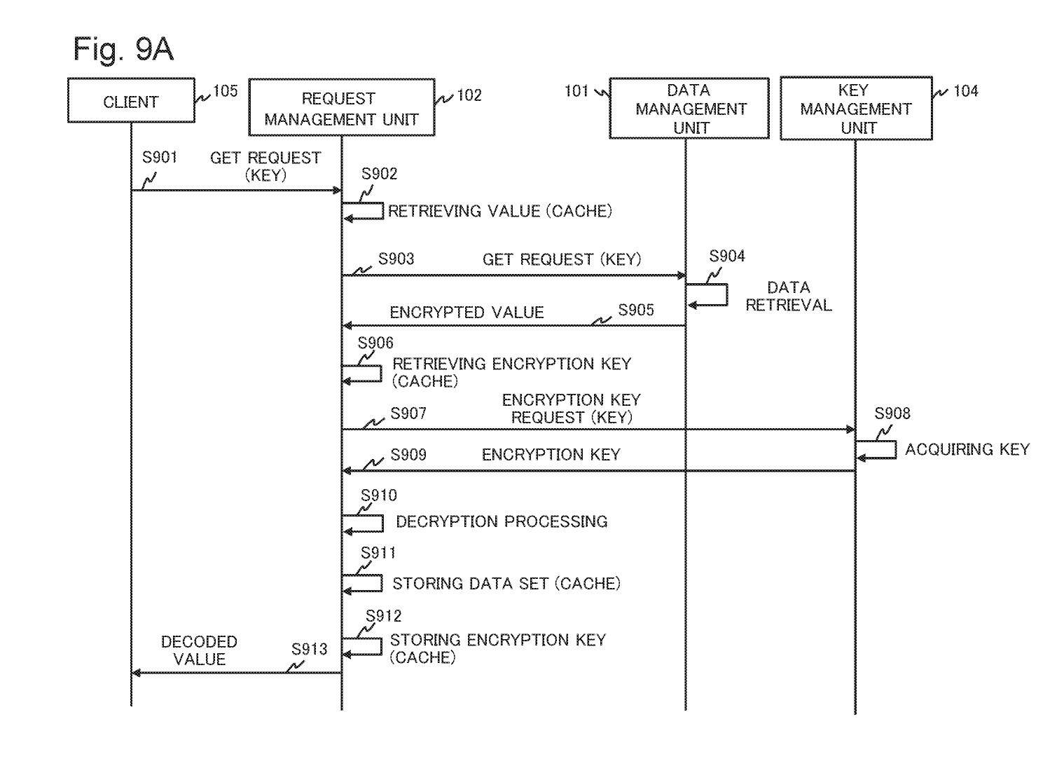

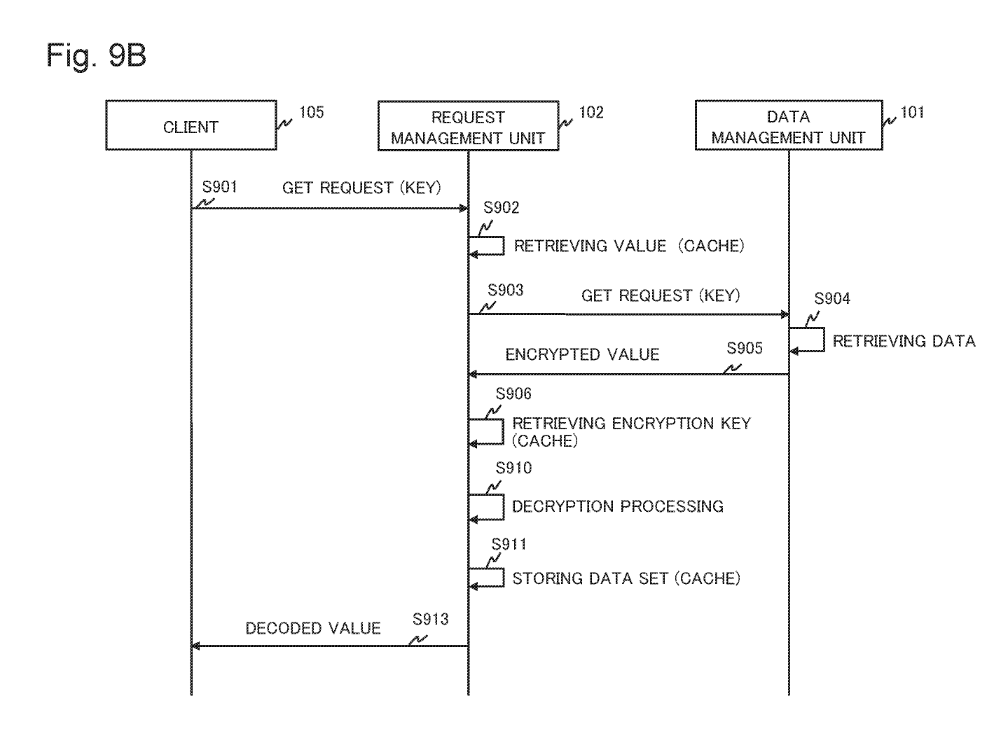

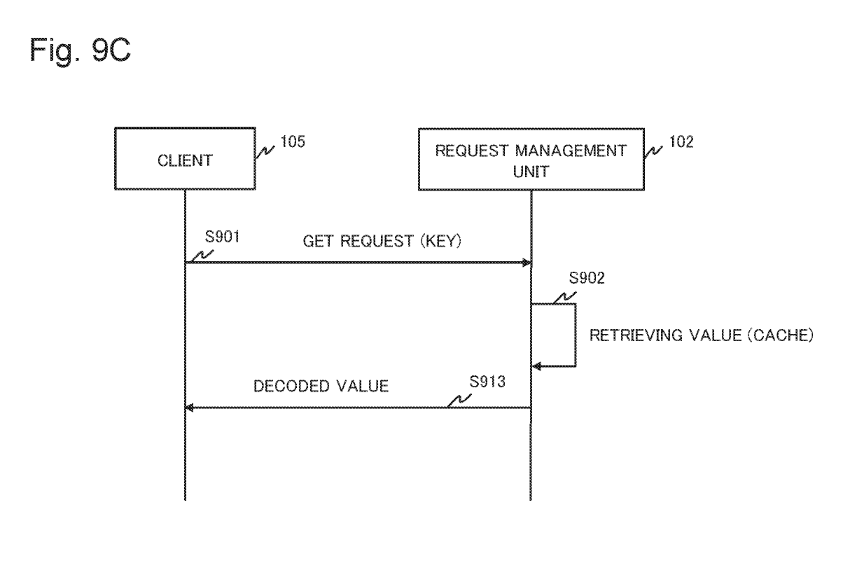

In the following, processing in a case where the client 105 sends a “GET” request to the data management system 1 after establishment of a communication session will be described with reference to FIG. 8, and FIG. 9A to FIG. 9C. FIG. 8 is an explanatory diagram representing an overview of “GET” processing, and FIG. 9A to FIG. 9C are sequence diagrams representing the processing. The sequences of the process illustrated in the sequence diagrams illustrated in FIG. 9A to FIG. 9C may be changed or may be executed in parallel, unless results are affected.

As illustrated in FIG. 8, the client 105 sends the request management unit 102 a request for “GET” processing ((“A”) in FIG. 8). The request management unit 102 sends a “GET” request to the data management unit 101 ((“B1”) in FIG. 8) and acquires encrypted data (VALUE) ((“C1”) in FIG. 8). Further, the request management unit 102 acquires an appropriate encryption key from the key management unit 104 ((“B2”), (“C2”) in FIG. 8), decrypts the data acquired from the data management unit 101, and returns the data to the client ((“D”) in FIG. 8).

Specifically, the client 105 specifies a particular KEY and sends the request management unit 102 the request for “GET” processing (step S901 in FIG. 9A). Hereinafter, a KEY specified in a “GET” request may be referred to as “requested KEY”.

The request management unit 102 (request processing unit 102c) searches the cached data storage 102e using the requested KEY (step S902).

When a VALUE associated with the requested KEY is not stored in the cached data storage 102e, the request processing unit 102c sends a “GET” request to the data management unit 101 (step S903) by specifying the requested KEY. A specific method for specifying a partition, in which a data set including the requested KEY is stored, will be described later.

The data management unit 101 that has received the “GET” request retrieves the VALUE associated with the requested KEY in the partitions of the KVS stored in the data storage 101a (step S904). The data management unit 101 sends the acquired VALUE to the request management unit 102 (step S905). The VALUE may be encrypted using an encryption key that is individually set for each partition (for example, such a VALUE is encrypted during “PUT” processing described later, and is stored in the KVS).

The request management unit 102 (request processing unit 102c) checks whether or not an encryption key associated with the partition including the requested KEY is stored in the cached key storage 102f (step S906).

When the encryption key is not stored in the cached key storage 102f, the request management unit 102 requests the key management unit 104 to acquire the encryption key (step S907). Specifically, the request processing unit 102c sends the requested KEY to the key management unit 104 (in particular, for example, to the communication unit 104d) via the key management communication unit 102h.

The key management unit 104 (key retrieval unit 104b) specifies the partition including the KEY by a hash value calculated from the requested KEY. The key management unit 104 acquires, from the key storage 104a, the encryption key stored to be associated with the specified partition (step S908), and sends the encryption key to the request management unit 102 via the communication unit 104d (step S909).

The processing of step S903 to step S905 and the processing of step S906 to S909 may be executed in parallel.

Then, the request management unit 102 (cryptographic processing unit 102d) uses the encryption key acquired in step S909 to decrypt the encrypted VALUE acquired in step S905 (step S910).

The request management unit 102 (request processing unit 102c) associates the VALUE decrypted in step S910 and the requested KEY with each other, and stores the VALUE and the requested KEY in the cached data storage 102e (step S911). Thereafter, the request processing unit 102c can provide the VALUE stored in the cached data storage 102e when “GET” processing is requested with the same KEY, by the client. As a result, the request management unit 102 can reduce a load and a delay caused by communication with the data management unit 101 and retrieval of data in the data management unit 101.

The request management unit 102 (request processing unit 102c) associates the encryption key acquired in step S909 with a partition ID, and stores the encryption key in the cached key storage 102f (step S912). As one specific example, it is assumed a case where the request management unit 102 acquires an encryption key (“b1”) associated with a partition ID “P2” from the key management unit 104, as illustrated in FIG. 8. In this case, the request management unit associates the encryption key with the partition ID “P2”, and stores the encryption key in the cached key storage 102f. As a result, the request management unit can reduces a load and a delay caused by communication with the key management unit 104 and retrieval of a key in the key management unit 104. In such a case, a TTL (402 in FIG. 4) is set for the encryption key stored in the cached key storage 102f.

The request management unit 102 sends the data decrypted in step S910 to the client 105 (step S913). Specifically, the request processing unit 102c provides, to the client communication unit 102a, the VALUE decrypted by the cryptographic processing unit 102d, and the client communication unit 102a sends the VALUE to the client 105.

In the “GET” processing described above, it is assumed a case where the encryption key associated with the partition including the requested KEY is stored in the cached key storage 102f. In such a case, the request management unit 102 may execute step S910, step S911, and step S913 without executing step S907, as illustrated in FIG. 9B.

Further, in the “GET” processing described above, it is assumed a case where the VALUE associated with the requested KEY is stored in the cached data storage 102e. In such a case, the request management unit 102 may execute step S902 and step S913, as illustrated in FIG. 9C.

In the “GET” processing described above, the client 105 may calculate the hash value of the KEY to specify a partition to which the hash value is assigned. The client 105 may send a “GET” request to the request management unit 102 that processes a request for the specified partition.

Alternatively, the client 105 may send a “GET” request to a particular request management unit 102. The request management unit 102 that has received the “GET” request from the client 105 may calculate the hash value of a specified KEY to specify a partition assigned with the hash value. In such a case, the request management unit 102 may transmit the “GET” request to the data management unit 101 that manages the specified partition in step S903.

The data management system 1 can provide transparent cryptographic processing to the client 105 by such “GET” processing as described above. That is, the client 105 can acquire plain text data of a VALUE regardless of whether or not the VALUE associated with a particular KEY is encrypted. This is because the request management unit 102 acquires, from the key management unit 104, an encryption key associated with a partition including a requested KEY, and uses the encryption key to decrypt the VALUE acquired from the data management unit 101. Further, the key management unit 104 individually associates encryption keys with respective partitions included in the KVS to manage the encryption keys, and therefore, the data management system 1 can execute cryptographic processing using the encryption keys differing according to the partitions.

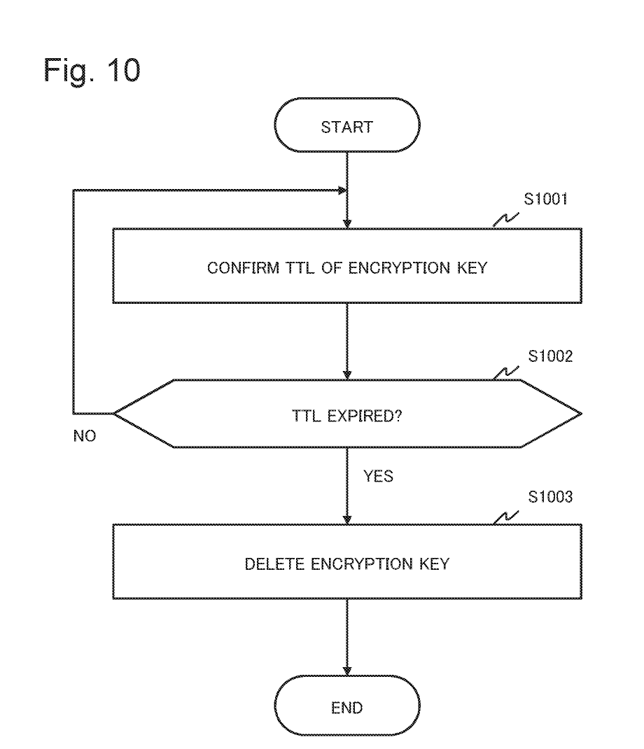

In the following, management of encryption keys stored in the cached key storage 102f will be described with reference to a flowchart illustrated in FIG. 10. As illustrated in FIG. 10, the key-life-cycle management unit 102g confirms the TTL (402 in FIG. 4) of the encryption key stored in the cached key storage 102f (step S1001). Specifically, for example, the key-life-cycle management unit 102g may regularly decrease the TTL of an encryption key and confirms whether or not the TTL becomes “zero”.

When the TTL of an encryption key expires (YES in step S1002), the key-life-cycle management unit 102g deletes the encryption key from the cached key storage 102f (step S1003).

The key-life-cycle management unit 102g may continue processing from step S1001 when the TTL is not expired.

By the processing of step S1001 to step S1003 described above, the request management unit 102 (key-life-cycle management unit 102g) can prevent encryption keys from being stored in the request management unit 102 for a long term. As a result, a risk of leakage of the encryption keys out of the request management unit 102 is reduced.

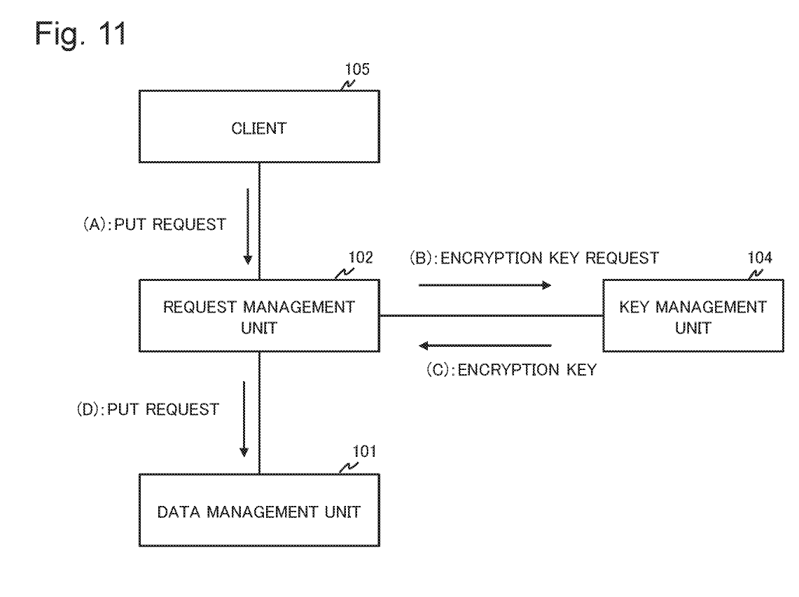

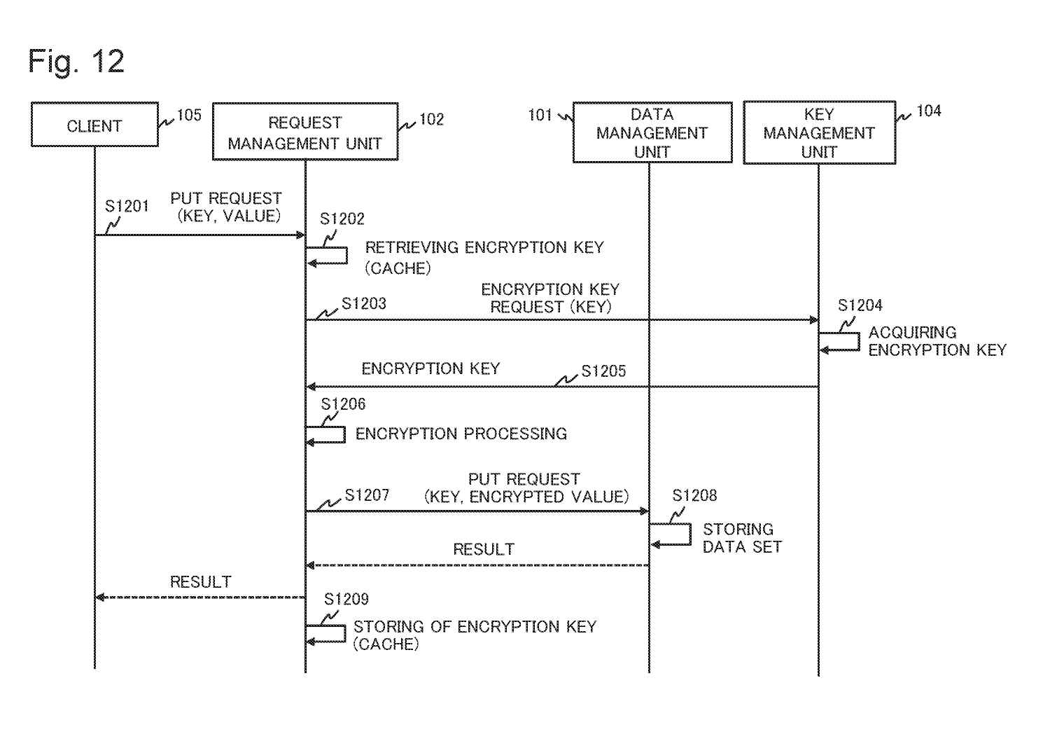

Processing in a case where the client 105 sends a “PUT” request to the data management system 1 will be described below with reference to FIG. 11 and FIG. 12. FIG. 11 is an explanatory diagram representing an overview of the “PUT” processing, and FIG. 12 is a sequence diagram representing the processing.

As illustrated in FIG. 11, the client 105 sends the request management unit 102 a request for “PUT” processing ((“A”) in FIG. 11). The request management unit 102 acquires an appropriate encryption key from the key management unit 104 ((“B”), (“C”) in FIG. 12). The request management unit 102 encrypts a data set (which is target for “PUT” processing) received from the client 105 using the encryption key acquired from the key management unit 104. The request management unit 102 sends the encrypted data to the data management unit 101 and requests “PUT” processing ((“D”) in FIG. 11).

Specifically, the client 105 specifies a pair (data set) of a particular KEY and a VALUE, and sends the request for “PUT” processing to the request management unit 102 (step S1201 in FIG. 12). Hereinafter, the data set included in the “PUT” request may be referred to as “requested data set”, and the KEY included in the “PUT” request may be referred to as “requested KEY”.

The request management unit 102 (request processing unit 102c) that has received the “PUT” request confirms whether or not an appropriate encryption key is stored (saved) in the cached key storage 102f (step S1202). Such processing may be similar to the processing in step S906 described above.

When the encryption key is not stored in the cached key storage 102f, the request management unit 102 requests the key management unit 104 to acquire the encryption key (step S1203). Specifically, the request processing unit 102c sends the requested KEY to the key management unit 104 (communication unit 104d) via the key management communication unit 102h.

The key management unit 104 (key retrieval unit 104b) acquires the encryption key associated with a partition including the requested KEY (step S1204). The key management unit 104 (key retrieval unit 104b) sends the acquired encryption key to the request management unit 102 via the communication unit 104d (step S1205). The processing in step S1204 and the processing in S1205 may be similar to those in steps S908 and S909 described above, respectively.

The request management unit 102 (cryptographic processing unit 102d) uses the encryption key acquired in step S1205 to encrypt a VALUE included in the requested data set (step S1206).

The request management unit 102 (request processing unit 102c) specifies a new data set in which the encrypted VALUE and the requested KEY are associated with each other, to send a “PUT” request to the data management unit 101 (step S1207).

The data management unit 101 stores (saves) the data set specified in the received “PUT” request, in a partition of the KVS stored in the data storage 101a (step S1208). The data management unit 101 may update data sets stored in the KVS using the data set specified in the “PUT” request.

The data management unit 101 may send the result of the processing of the “PUT” request to the request management unit 102. The request management unit 102 may send the result of the processing of the “PUT” request to the client 105.

The request management unit 102 may associate the encryption key acquired in step S1205 with a partition ID, and store the encryption key in the cached key storage 102f (step S1209). The processing in step S1209 may be similar to the processing in step S912 described above.

In the “PUT” processing described above, it is assumed a case where the encryption key associated with the partition including the requested KEY is stored in the cached key storage 102f. In such a case, the request management unit 102 may execute step S1206 and step S1207 without executing step S1203.

In the “PUT” processing described above, the client 105 may calculate the hash value of a KEY stored in the KVS to specify a partition including the KEY. The client 105 may directly send a “PUT” request to a node (for example, request management unit 102 or data management unit 101) that manages the specified partition.

Alternatively, the client 105 may send a “PUT” request to a specific request management unit 102. The request management unit 102 that has received the “PUT” request from the client 105 may calculate the hash value of a specified KEY to specify a partition including the KEY. In such a case, the request management unit 102 may transmit a “PUT” request to the data management unit 101 that manages the specified partition in step S1207.

The data management system 1 can provide transparent cryptographic processing to the client 105 by such “PUT” processing as described above. That is, the client 105 need not explicitly to encrypt a data set stored in the KVS by a “PUT” request but may send the plaintext data set to the request management unit 102. This is because the request management unit 102 encrypts the data set specified in the “PUT” request using an appropriate encryption key acquired from the key management unit 104. Further, the key management unit 104 individually associates encryption keys with respective partitions included in the KVS to manage the encryption keys, and therefore, the data management system 1 can execute cryptographic processing using different encryption keys according to the partitions.

The request management unit 102 can process requests (for example, “DELETE request” and the like) other than the “GET” and “PUT” requests described above by a similar method. That is, on the basis of a KEY specified in a request, the request management unit 102 specifies a partition in which a data set including the KEY is stored. The request management unit 102 executes appropriate processing of the data set included in the specified partition, according to the received request.

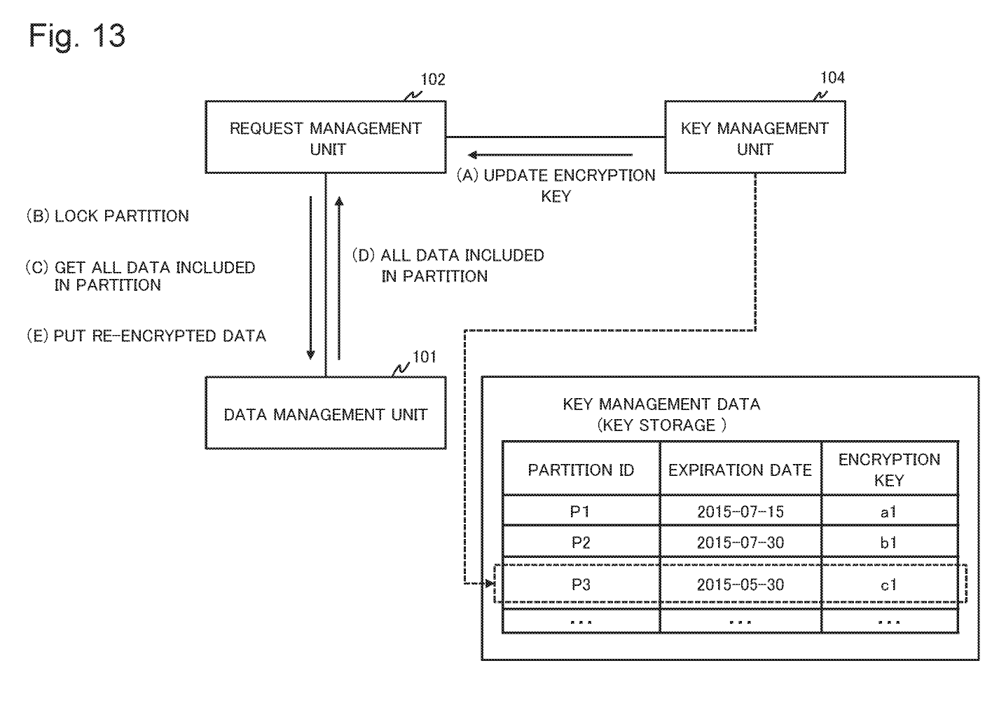

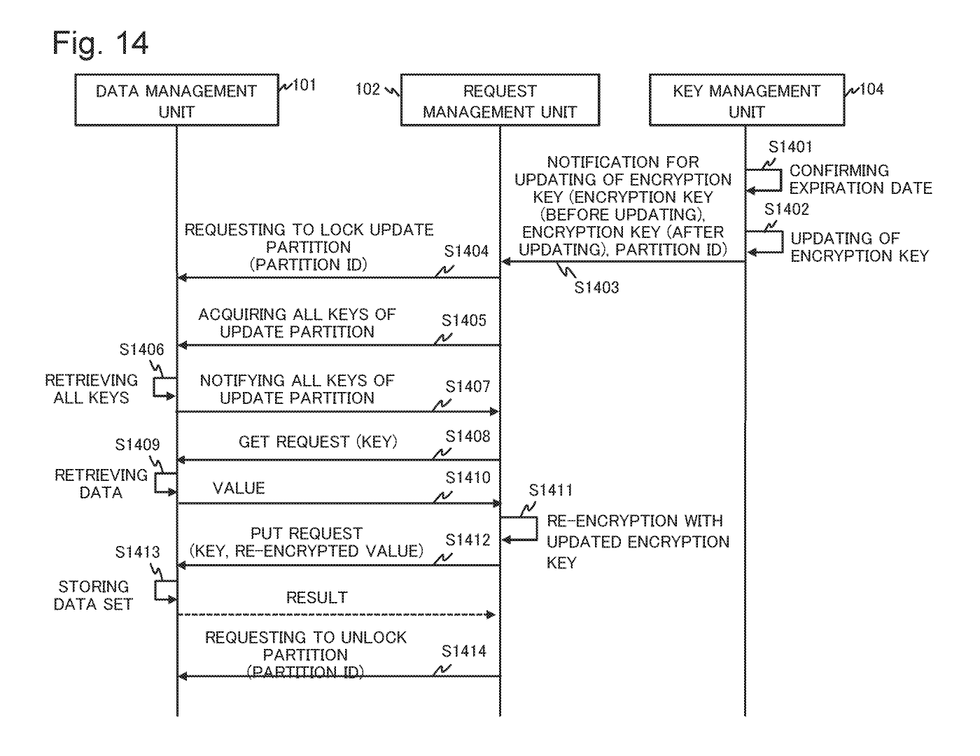

In the following, processing of updating encryption keys stored in the key management unit 104 will be described with reference to FIG. 13 and FIG. 14. FIG. 13 is an explanatory diagram representing an overview of the processing of updating the encryption keys, and FIG. 14 is a sequence diagram representing the processing.

As illustrated in FIG. 13, the key management unit 104 (expiration management unit 104c) confirms the expiration dates of the encryption keys stored in the key storage 104a. When the expiration date of a particular encryption key is reached, the key management unit 104 notifies the request management unit 102 of the updating of the encryption key ((“A”) in FIG. 13). The request management unit 102 that has received such a notification requests the data management unit 101 to lock a partition associated with the updated encryption key ((“B”) in FIG. 13), and acquires all data sets included in the partition ((“C”), (“D”) in FIG. 13). The request management unit 102 stores, in the data management unit 101, data sets re-encrypted by use of the encryption keys before and after the updating ((“E”) in FIG. 13).

Specifically, the key management unit 104 (expiration management unit 104c) confirms the expiration dates (for example, 502 in FIG. 5) of the encryption keys stored in the key storage 104a (step S1401). As a specific example, it is assumed in below that the expiration date (“2015-05-30”) of an encryption key associated with a partition ID “P3” illustrated in FIG. 5 is reached. Hereinafter, a partition associated with an encryption key to be updated may be referred to as “update partition”.

The key management unit 104 (expiration management unit 104c) updates an encryption key of which the expiration date has been reached (in this specific example, encryption key “c1” associated with partition ID “P3”) (step S1402). Further, the key management unit 104 changes the expiration date associated with the updated encryption key. For example, the expiration management unit 104c updates the encryption key “c1” to an encryption key “c2”, and changes its expiration date from “2015-05-30” to “2015-08-30”.

The key management unit 104 notifies the request management unit 102 of the updating of the encryption key (step S1403). Specifically, the expiration management unit 104c sends the encryption key before the updating, the encryption key after the updating, and information for specifying the update partition to the request management unit 102 via the communication unit 104d. For example, the expiration management unit 104c sends the encryption key “c1”, the encryption key “c2”, and the partition ID “P3” to the request management unit 102.

The request management unit 102 requests the data management unit 101 to lock update partitions (for example, partition ID “P3”) (step S1404). When the partitions are locked, for example, execution of “GET” processing and “PUT” processing of the partitions is suppressed. The key management communication unit 102h in the request management unit 102 receives the notification of the updating of the encryption key, and sends the notification to the re-encryption processing unit 102i.

Then, the request management unit 102 requests the data management unit 101 to acquire all KEYs included in the update partitions (step S1405). Specifically, the re-encryption processing unit 102i sends the partition IDs of the update partitions to the data management unit 101, and requests the acquisition of all the KEYs included in the partitions.

Step S1404 and step S1405 in the above description may be merged. In other words, the data management unit 101 may lock the update partitions when the request management unit 102 requests the data management unit 101 to acquire all the KEYs of the update partitions.

The data management unit 101 (all-keys-retrieval unit 101c) that has received the request of acquiring all the KEYs of the update partitions retrieves the KEYs of all data sets included in the update partitions stored in the data storage 101a (step S1406). The data management unit 101 sends the results of the retrieval to the request management unit 102 (step S1407).

The request management unit 102 sends “GET” requests the KEYs of all the data sets included in the update partitions (step S1408). Specifically, the re-encryption processing unit 102i specifies the KEYs included in the update partitions to send the “GET” requests to the data management unit 101.

The data management unit 101 processes such a “GET” request (step S1409), and returns a VALUE (step S1410). The processing in step S1409 and the processing in step S1410 may be similar to those in step S904 and step S905, respectively.

Then, the request management unit 102 (re-encryption processing unit 102i) decrypted the VALUE received in step S1410, using the encryption key before the updating, acquired in step S1403. The request management unit 102 (re-encryption processing unit 102i) re-encrypts the decrypted VALUE using the encryption key after the updating (step S1411).

The request management unit 102 specifies a KEY and the VALUE re-encrypted in step S1411 described above, and sends a “PUT” request to the data management unit 101 (step S1412). Step S1412 may be similar to step S1207 described above.

The data management unit 101 that has received the “PUT” request, stores the specified data set in the KVS. Specifically, the data management unit 101 stores the specified data set in the data storage 101a (step S1413). Step S1413 may be similar to step S1208 described above. The data management unit 101 may send the result of the processing of the “PUT” request to the request management unit 102.

When the processing in step S1408 to step S1413 described above is executed for all the KEYs included in the update partitions, the request management unit 102 may request the data management unit 101 to unlock the update partitions (step S1414).

The request management unit 102 can re-encrypt data sets registered in partitions to be updated by, for example, repeatedly executing the processing in step S1408 to step S1412 described above for all the KEYs acquired in step S1407.

When receiving the notification in step S1403, the request management unit 102 (key-life-cycle management unit 102g) may check whether the encryption key before the updating being included in the notice is stored in the cached key storage 102f. When the encryption key before the updating is stored in the cached key storage 102f, the key-life-cycle management unit 102g may delete the encryption key before the updating from the cached key storage 102f. In such a case, the key-life-cycle management unit 102g may store the encryption key after the updating and TTL of the updated encryption key in the cached key storage 102f. As a result, the key-life-cycle management unit 102g prevents mismatches between the encryption keys stored in the key management unit 104 and the encryption keys stored in the cached key storage 102f.

In the data management system 1 configured as described above, partitions into which the KVS is divided are individually assigned with encryption keys for encrypting data sets included in the partitions, respectively (key storage 104a). That is, the data sets (particularly, VALUEs) included in the respective partitions are encrypted using the individual encryption keys associated with the partitions, respectively. As a result, the range of data, stored in KVS, encrypted using one encryption key is divided in unit of partitions. Therefore, the affected range of data stored in KVS in case of leakage of one encryption key can be limited. Accordingly, the data management system 1 can reduce a risk in a case of leakage of an encryption key, in comparison with the case of encrypting all data using a single encryption key.

In addition, the data management system 1 configured as described can equalize loads in the case of updating encryption keys in respective partitions. For example, in the case of encrypting all data included in a database using a single encryption key, it is necessary to re-encrypt all the data when the encryption key is updated. On the other hand, the data management system 1 associates individual encryption keys with respective partitions, and therefore, the range of data re-encrypted due to updating of the encryption keys is divided in unit of partition. As a result, the loads of the re-encryption caused by updating the encryption keys are distributed. When the sizes of the data sets included in the respective partitions are equal or substantially equal, the loads of the re-encryption processing are also equally or substantially equally distributed. Further, the data management system 1 (particularly, expiration management unit 104c) can set the expiration dates of the encryption keys in the respective partitions at different values. As a result, the encryption keys are updated at timing varying depending on the partitions, and therefore, the data management system 1 can distribute the loads of the re-encryption processing over time.

In the data management system 1 configured as described above, the KEYs of data sets stored in the KVS are used to specify partitions including the data sets. This is because the KVS is divided into partitions using a consistent hashing method, and the partitions including the KEYs are specified based on the hash values of the KEYs. As a result, encryption keys used in cryptographic processing for the data sets can be specified using the KEYs of the data sets stored in the KVS.

In addition, the data management system 1 configured as described above can provide transparent cryptographic processing to a client (for example, client 105). In other words, it is not necessary that the client executes specific cryptographic processing of data stored in the data management system 1. This is because the request management unit that has accepted a request (for example, “PUT” request) from the client appropriately encrypts a data set specified in the request and stores the data set in the KVS. This is also because the request management unit that has accepted a request (for example, “GET” request) from a client appropriately decrypts data stored in the KVS and notifies the client of the data.

As described above, the data management system 1 in the present example embodiment is able to divide a database into partial areas (for example, partitions) having an appropriate granularity, and to individually execute cryptographic processing for the divided respective areas.

### Alternative Example of First Example Embodiment

An alternative example of the first example embodiment described above will be described below. A data management system 1 in the present alternative example may configured to be similar to the data management system 1 in the first example embodiment described above.

In the present alternative example, an encryption key is updated without locking a partition associated with the encryption key to be updated, when the encryption key is updated.

In such a case, a request management unit 102 requests a data management unit 101 to acquire all KEYs registered in the partition without locking the partition. In this case, the request management unit 102 may set, for example, a flag representing that the request management unit 102 is in the process of re-encryption processing. Such a flag enables a client 105 or another request management unit 102 to identify the request management unit 102 executing the re-encryption processing.

Thereafter, the data management unit 101 executes processing similar to the processing in the first example embodiment described above. In other words, the request management unit 102 sends “GET” requests to the data management unit 101 using all KEYs, and acquires pairs of the KEYs and VALUEs. The request management unit 102 decrypts the VALUEs using encryption keys before updating, and re-encrypts the VALUEs using encryption keys after the updating. The request management unit 102 specifies KEYs and the re-encrypted VALUEs, and sends “PUT” requests to the data management unit 101.

In the following, a case where particular request management unit 102 receives a “GET” request from the client 105 during executing re-encryption processing will be described. In this case, the request management unit checks KEYs set in “GET” requests, and confirms whether or not VALUEs associated with the KEYs have been already re-encrypted. For example, the request management unit 102 may manage pairs that have been re-encrypted, by distinguishing those pairs from pairs of KEYs and VALUEs that has not been re-encrypted in a particular partition. Thereby the request management unit 102 can check whether or not a VALUE associated with a particular KEY has been re-encrypted. For one specific example, the request management unit 102 may use a flag representing whether or not a KEY registered in a partition under re-encryption has been re-encrypted. For another example, the request management unit 102 may use a re-encryption-finished list, and the like, which includes a list of KYEs having been already encrypted. Without being limited to above described method, the request management unit 102 may select another method appropriately to determine whether or not re-encryption has been finished.

When a VALUE associated with a KEY in the “GET” request has been already re-encrypted, the request management unit 102 decrypts the VALUE using an encryption key after updating. A pair of the KEY and the decrypted VALUE is sent to the client 105. When a VALUE associated with a KEY in a “GET” request has not been re-encrypted yet, the request management unit 102 decrypts the VALUE using an encryption key before updating. A pair of the KEY and the decrypted VALUE is sent to the client 105.

In the following, another case where the request management unit 102 receives a “PUT” request from the client 105 during executing re-encryption processing will be described. In this case, the request management unit 102 encrypts a VALUE set in the “PUT” request by an encryption key after updating. The request management unit 102 sends the “PUT” request to the data management unit 101, using a pair of a KEY set in the received “PUT” request and the encrypted VALUE.

For example, when receiving, from the client 105, a “GET” (or “PUT”) request for a KEY registered in a partition under re-encryption, a request management unit 102 may transmit the request to the request management unit 102 executing the re-encryption processing of the partition. Alternatively, each request management unit 102 that has received a request from the client 105 may decrypt and encrypt a VALUE using encryption keys before and after updating, associated with the partition targeted for the re-encryption. In such a case, the request management unit 102 executing the re-encryption processing excludes pairs of KEYs and VALUEs that have been already updated (i.e., re-encrypted) by the other request management units 102, from targets for re-encryption. For example, by executing check-and-set (CAS) manipulation, the request management unit 102 can confirm whether a pair of a particular KEY and a VALUE has been updated.

The data management system 1 in the present alternative example being configured as described above can execute re-encryption processing without locking a partition when an encryption key is updated. In addition, the data management system 1 in the present alternative example includes a configuration similar to that in the first example embodiment described above, and therefore can achieve effects similar to those in the first example embodiment described above.

### Second Example Embodiment

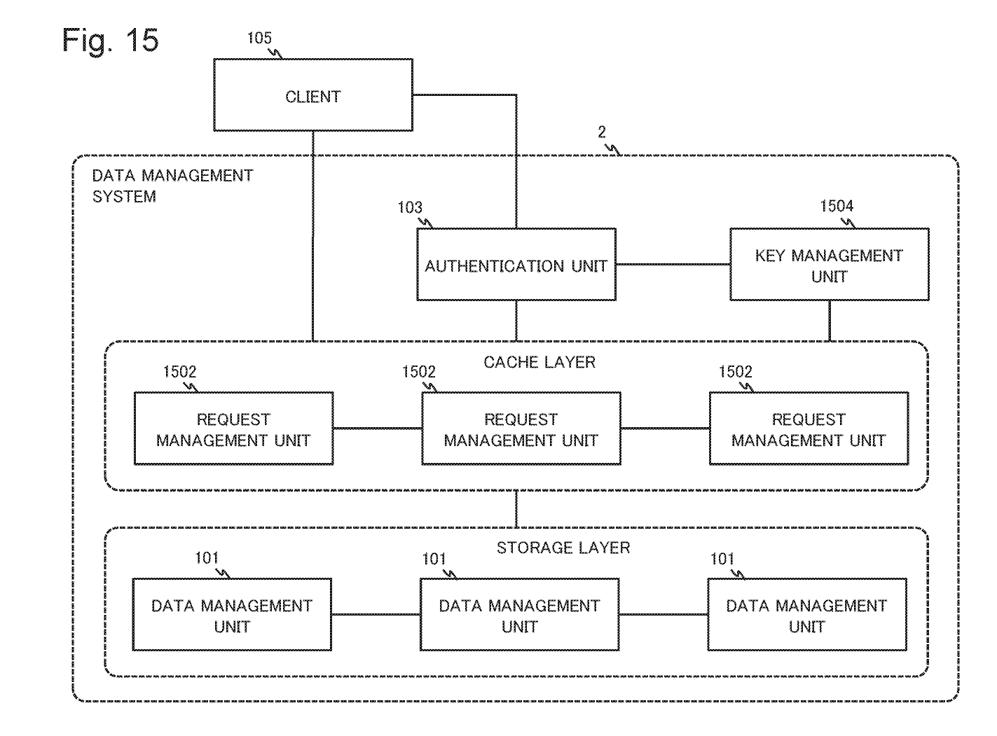

A second example embodiment of the present disclosure will be described with reference to the drawings. FIG. 15 is a block diagram illustrating the functional configuration of a data management system 2 in the present example embodiment. The functional configuration illustrated in FIG. 15 is one specific example. One or more components may be merged, or each component may be further divided. Arrangement of each component may be changed as appropriate as long as similar functionalities can be achieved. The present example embodiment may be combined with the first example embodiment as appropriate.

The data management system 2 (FIG. 15) in the present example embodiment enhances the data management system 1 in the first example embodiment so as to be able to execute different level of cryptographic processing according to a air (data set) of a KEY and a VALUE. Such enhancements will be mainly described below. The same configurations as those of the first example embodiment described above are assigned with the same reference signs, and the detailed descriptions thereof are omitted.

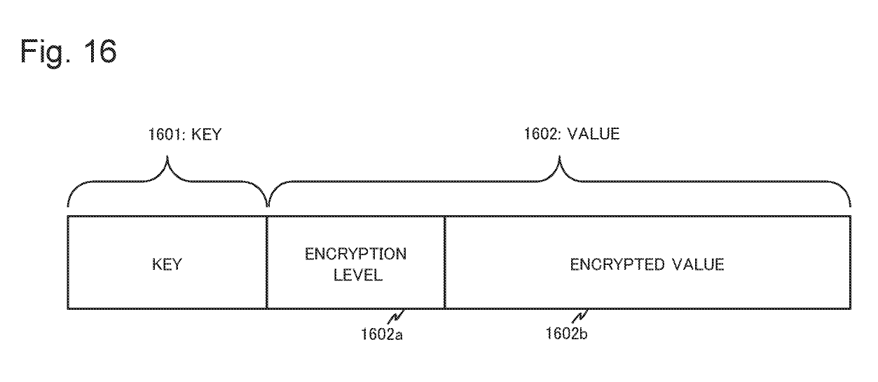

FIG. 16 is an explanatory diagram illustrating the conceptual configuration of a data set stored in a KVS in the data management system 2. The data management system 2 in the present example embodiment stores, in the KVS, a data set in which a KEY (1601 in FIG. 16) and a VALUE (1602 in FIG. 16) are associated with each other, as illustrated in FIG. 16. The VALUE 1602 includes data (1602a in FIG. 16) representing an encryption level and encrypted data (1602b in FIG. 16).

The encryption level 1602a represents a level of security relating to cryptographic processing for the VALUE 1602 (specifically, encrypted VALUE 1602b stored in KVS), or a kind of cryptographic processing, or the like. The VALUE 1602b is encrypted (or decrypted) based on the setting of the encryption level 1602a. As a result, the types of cryptographic processing executed for respective pieces of data differ according to the setting of the encryption level 1602a, even if the pieces of data are stored in the same partition.

The encryption level may be represented by a numerical value, a reference character, a character string, or the like. In a specific example for description, it is assumed below that the encryption level is represented using a numerical value. In such a case, for example, an encryption level “0” may represent that cryptographic processing is not executed, an encryption level “1” may represent that a standard encryption key is used, and an encryption level “2” may represent that a highly secure encryption key is used.

As another specific example, an encryption algorithm used in cryptographic processing may be switched depending on the setting of the encryption level 1602a. In such a case, for example, an encryption level “0” may represent that cryptographic processing is not executed, an encryption level “1” may represent that a standard encryption algorithm is used, and an encryption level “2” may represent that a highly secure encryption algorithm is used. The data management system 2 may adopt a known encryption algorithm of which security (strength) is confirmed. The initial value of an encryption level that can be processed by the data management system 2 may be set in advance, or may be changed according to, for example, the stage of operation of the system.

The encryption level 1602a may be arranged in the head of the VALUE 1602, may be arranged in the end thereof, or may be arranged in a position appropriately offset from the top or end thereof. The size of the encryption level 1602a may be set in advance. In a specific example, it is assumed below that the encryption level 1602a is arranged in the head of the VALUE 1602.

In the data management system 2 which handles such a data set, the functionalities of a request management unit 1502 and a key management unit 1504 are enhanced in comparison with those in the data management system 1 in the first example embodiment described above, respectively. The specific structural configurations of the request management unit 1502 and the key management unit 1504 may be similar to the configurations illustrated in FIG. 3. The components described above will be described below.

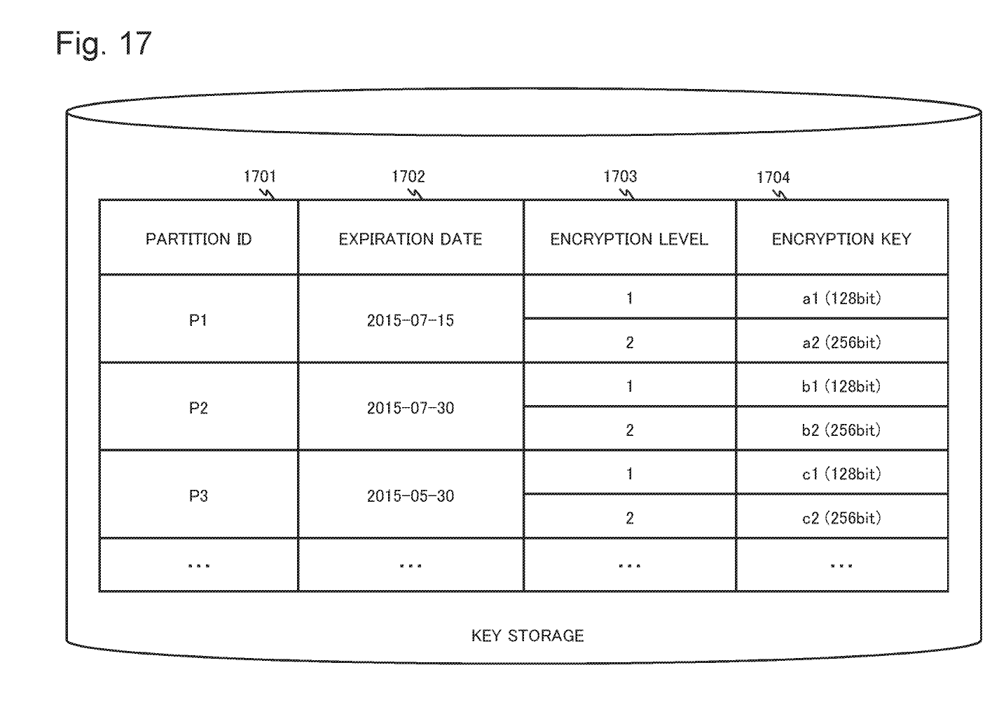

As illustrated in FIG. 17, he key management unit 1504 stores partition IDs (1701 in FIG. 17), expiration dates (1702 in FIG. 17), encryption levels (1703 in FIG. 17), and encryption keys (1704 in FIG. 17) by associating them with each other. The key management unit 1504 may store these data in a key storage 104a. The initial values of encryption keys in each partition may be set in advance depending on corresponding encryption levels, or may be generated as appropriate by a key management unit 104 when the partition is created.

When the KEY of a particular data set is specified the from request management unit 1502, the key management unit 1504 specifies a partition including the KEY, like the first example embodiment described above. The key management unit 1504 provides an encryption key associated with the specified partition ID to the request management unit 1502. When only a KEY is specified by the request management unit 1502, the key management unit 1504 may notify the request management unit 1502 of pairs of all encryption keys 1704, being associated with a partition including the KEY, and their encryption levels 1703. When a KEY and an encryption level are specified by the request management unit 1502, the key management unit 1504 may notify the request management unit 1502 of an encryption key 1704 associated with the specified encryption level, of encryption keys 1704 associated with a partition including the KEY.

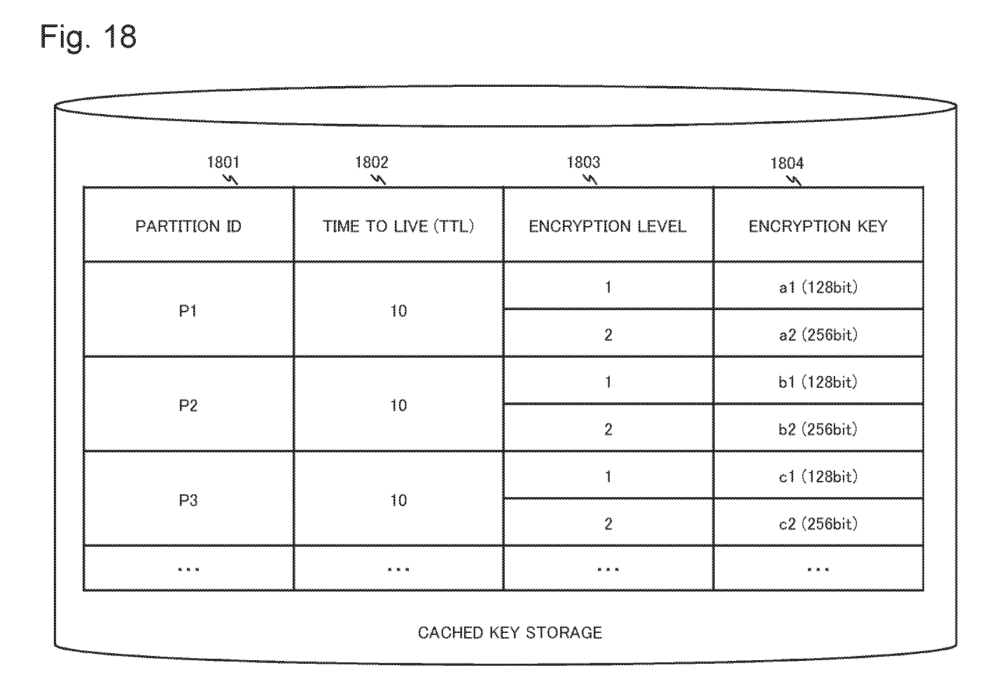

As illustrated in FIG. 18, the request management unit 1502 stores partition IDs (1801 in FIG. 18), TTL (1802 in FIG. 18), encryption levels (1803 in FIG. 18), and encryption keys (1804 in FIG. 18) by associating them with each other. The request management unit 1502 may associate, for example, an encryption key acquired from the key management unit 104 and its encryption level with each other, and store the encryption key and the encryption level in a cached key storage 102f. The specific structural configuration of the request management unit 1502 may be similar to that in the first example embodiment described above.

The request management unit 1502 decrypts a VALUE associated with a KEY specified by a “GET” request from a client, by using an appropriate encryption key according to an encryption level set in the VALUE. The request management unit 1502 encrypts a VALUE included in a data set specified by a “PUT” request from the client, by using an appropriate encryption key according to an encryption level set in the VALUE.

The operation of the data management system 2 in the present example embodiment will be described below.

First, a case where the request management unit 1502 receives a “PUT” request from the client 105 will be described. In the following description, as specific example, it is assumed that the “PUT” request sent from the client 105 includes the pair (data set) of the KEY 1601 and the VALUE 1602 formed as illustrated in FIG. 16.

The request management unit 1502 extracts a KEY and an encryption level from the data set included in the “PUT” request. The request management unit 1502 notifies the key management unit 1504 of the requested KEY (or KEY and encryption level) to acquire an encryption key. The encryption key is an encryption key corresponding to the specified encryption level, of encryption keys associated with a partition including the data set in the “PUT” request.

As a specific example, it is assumed that the data set (for example, hereinafter referred to as “data set ‘D”) specified in the “PUT” request is included in a partition with a partition ID “P1” illustrated in FIG. 17 and FIG. 18 (hereinafter simply referred to as “partition P1”). When the encryption level set in the data set “D” is “1”, the request management unit 1502 encrypts a VALUE included in the data set “D” using an encryption key “a1” (key length of 128 bit). The request management unit 1502 may encrypt the VALUE included in the data set D using an encryption key (for example, encryption key “a1”) corresponding to a default encryption level (for example, “1”) when no encryption level is set in the data set “D”. The default encryption level may be set as appropriate. When the encryption level set in the data set “D” is “2”, the request management unit 1502 encrypts the VALUE included in the data set “D” using an encryption key “a2” (key length of 256 bit). When the encryption level set in the data set “D” is “0”, the request management unit 1502 does not encrypt the VALUE included in the data set “D”. As described above, the request management unit 1502 can switch cryptographic processing executed for the VALUE included in the data set “D” according to the encryption level set in the data set “D”.

The request management unit 1502 creates a new VALUE by arranging an encryption level set in the data set “D” in the head of the VALUE for which the cryptographic processing described above has been executed. In a case in which the VALUE of data set “D” is not encrypted (in the case of an encryption level is set as “0”), the request management unit also similarly creates a new VALUE by arranging an encryption level in the head of the VALUE that is not encrypted. The request management unit 1502 sends the “PUT” request to a data management unit 101 by using a data set in which the KEY in the data set “D” and the VALUE including the encryption level and being created as described above are associated with each other.

Like the first example embodiment described above, the data management unit 101 that has received the “PUT” request stores the data set specified in the request in the partition of KVS.

The request management unit 1502 may check whether or not an encryption key used in encryption of the VALUE included in the data set “D” is stored in the cached key storage 102f. When the encryption key is stored in the cached key storage 102f, the request management unit 1502 may encrypt the VALUE included in the data set “D” using the encryption key.

In the following, a case where the request management unit 1502 receives a “GET” request from the client 105 will be described.

Like the first example embodiment described above, the client 105 specifies a particular KEY, and sends a “GET” request to the request management unit 1502. The client 105 needs not to specify an encryption level in the “GET” request.

The request management unit 1502 specifies the requested KEY, and sends a “GET” request to the data management unit 101. The request management unit 1502 checks an encryption level included in a VALUE acquired from the data management unit 101. The request management unit 1502 specifies the requested KEY (or requested KEY and encryption level), and acquires an encryption key from the key management unit 1504. The acquired encryption key corresponds to an encryption level included in the VALUE acquired from the data management unit 101, and is of encryption keys associated with the partition including the KEY in the received “GET” request. The request management unit 1502 uses the encryption key to decrypt the VALUE acquired from the data management unit 101, and sends the decrypted VALUE to the client 105.

When an appropriate encryption key is stored in the cached key storage 102f, the request management unit 1502 may decrypt the VALUE acquired from the data management unit 101 by the encryption key stored in the cached key storage 102f, like the case of the “PUT” request.

The other processing in the data management system 2 in the present example embodiment may be similar to that in the data management system 1 in the first example embodiment described above.

The data management system 2 configured as described above can change cryptographic processing executed for a VALUE included in a data set, according to the data set which is a unit smaller than a partition. This is because the data management system 2 switches the cryptographic processing executed for the VALUE included in the data set based on an encryption level set in the data set (particularly, VALUE).

More specifically, the data management system 2 can encrypt or decrypt VALUEs included in data sets using, for example, encryption keys having different cryptographic strengths (for example, key lengths) according to encryption levels set in the data sets, respectively. Further, the data management system 2 can encrypt or decrypt the VALUEs included in the data sets using, for example, encryption algorithms being different according to the encryption levels set in the data sets, respectively.

As a result, according to the importance (requirement of confidentiality) of data sets stored in the KVS, the data management system 2 can provide appropriate securities for the data sets, respectively. Further, a risk in a case of leakage of an encryption key can be reduced when different encryption keys are set according to encryption levels, respectively. Further, the data management system 2 includes a configuration similar to that of the data management system 1 in the first example embodiment described above, and therefore can achieve an advantageous effect similar to that in the first example embodiment described above.

### Third Example Embodiment

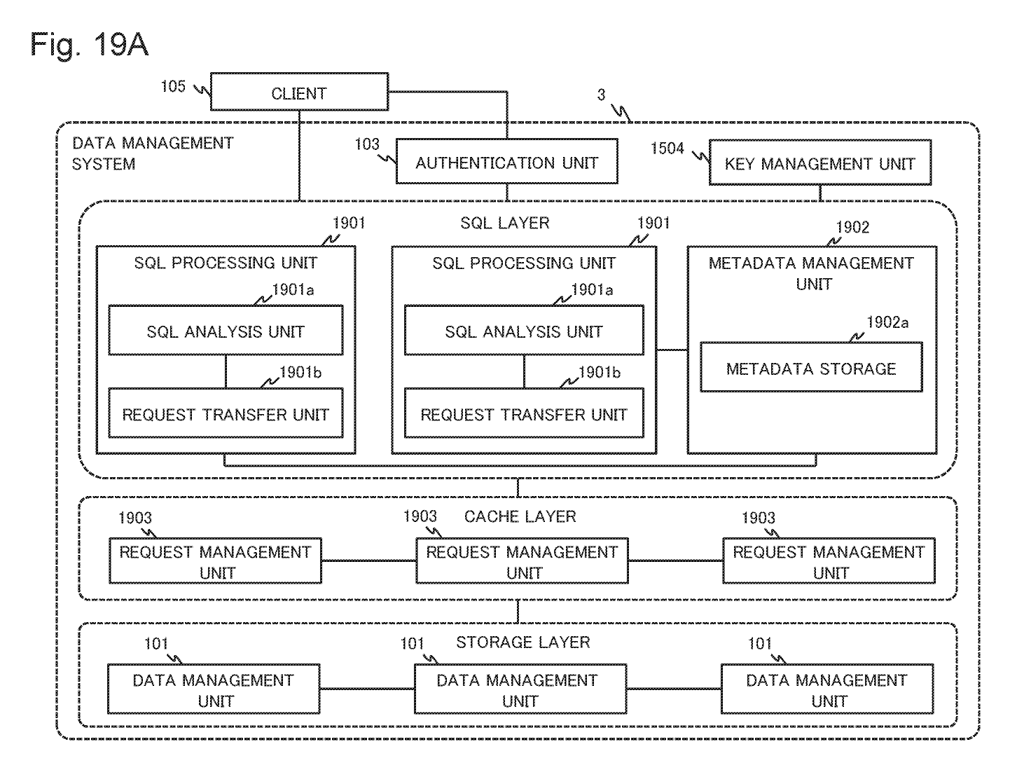

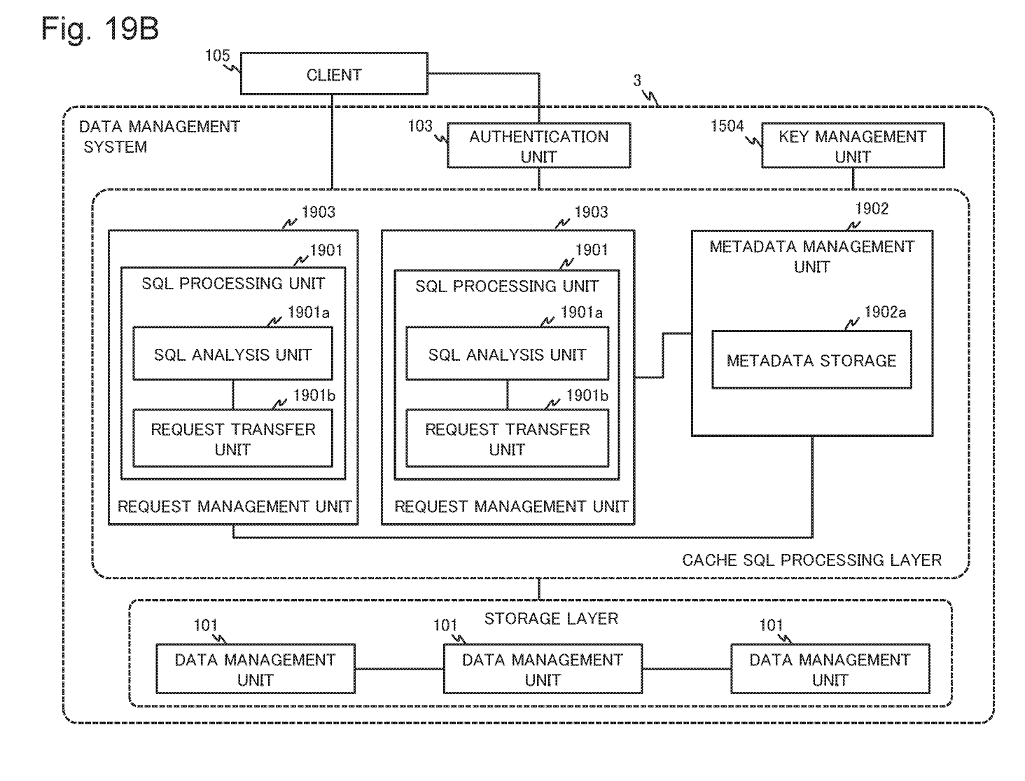

A third example embodiment of the present disclosure will be described below with reference to the drawings. FIG. 19A is a block diagram illustrating the functional configuration of a data management system 3 in the present example embodiment. The functional configuration illustrated in FIG. 19A is one specific example. One or more components may be merged, or each component may be further divided. Arrangement of each component may be changed as appropriate as long as similar functionalities can be achieved. The present example embodiment may be combined with each of the above-described example embodiments as appropriate.

The data management system 3 (FIG. 19A) in the present example embodiment is a system that enhances each of the example embodiments described above, so as to function as a database management system (DBMS) for a client 105. In a specific example for description, it is assumed below that the data management system 3 provides a relational database (RDB) to the client 105, and processes an SQL query from the client 105. The present example embodiment is not limited thereto, and the data management system 3 may provide a database of which the schema is different from that of the RDB.

In the relational database, the importance of stored information may differ according to respective table. The data management system 3 in the present example embodiment can apply, for example, cryptographic processing at different encryption levels according to tables, respectively. For convenience of description, hereinafter, a table included in the relational database may be referred to as “RDB table”.

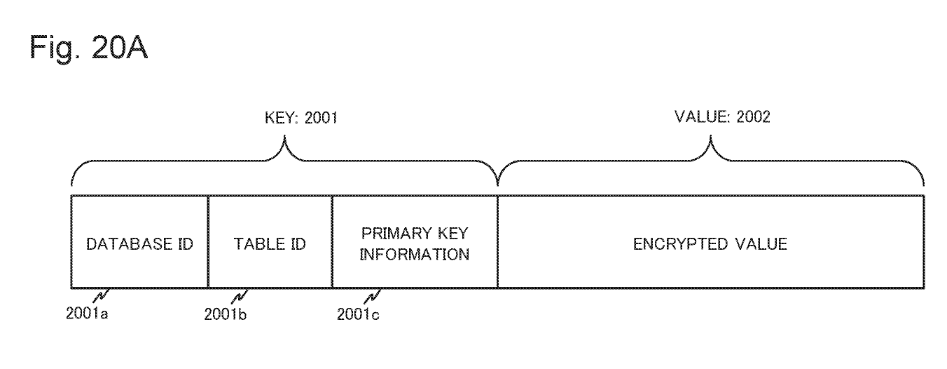

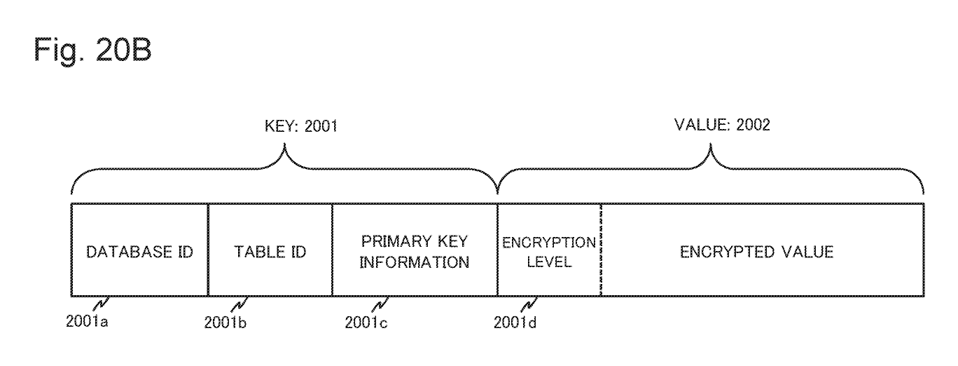

First, a data set stored in a KVS managed by the data management system 3 will be described. FIG. 20A is an explanatory diagram illustrating the conceptual configuration of the data set stored in the KVS by the data management system 3. The configuration of the data set illustrated in FIG. 20A represents one specific example format by which data stored in the RDB table of the relational database (data stored in table format) is stored in the KVS. A specific method of mapping the schema of the relational database into a KVS can be realized by adopting a known technique.

A KEY (2001 in FIG. 20A) in the data set stored in the KVS in the present example embodiment includes a database ID (2001a in FIG. 20A), a table ID (2001b in FIG. 20A), and primary KEY information (2001c in FIG. 20A), as illustrated in FIG. 20A. The database ID 2001a is information for identifying a relational database. The table ID 2001b is information for identifying an RDB table included in the relational database. The primary KEY information is information for identifying a primary KEY included in a particular RDB table. In other words, the KEY 2001 is information for identifying a primary KEY (value of a particular column) included in an RDB table included in a particular relational database. Arrangement of the database ID 2001a, the table ID 2001b, and the primary KEY information 2001c in the KEY 2001 may be selected as appropriate. For example, the data included in a row including a KEY specified by the KEY 2001 in a relational database, is set in a VALUE 2002 being associated with the KEY 2001. The VALUE 2002 may include an encryption level (2001d in FIG. 20B) as illustrated in FIG. 20B.

Each component of the data management system 3 will be described below. Configurations similar to those of each of the example embodiments described above are assigned with the same reference signs, whereby the descriptions thereof are omitted.

The data management system 3 in the present example embodiment further includes an SQL processing unit 1901 and a metadata management unit 1902 with respect to the second example embodiment described above. The data management system 3 in the present example embodiment includes a request management unit 1903 which enhances methods of processing a “GET” request and a “PUT” request, from to the request management unit 1502 in the second example embodiment.

The data management system 3 may use plural SQL processing units 1901 to form a virtual SQL layer. In the specific example illustrated in FIG. 19A, the SQL processing unit 1901 and the metadata management unit 1902 are expressed as individual components. However, the present example embodiment is not limited thereto. For example, the SQL processing unit 1901 may include the metadata management unit 1902 in the data management system 3. Furthermore, the data management system 3 may be configured so that the request management unit 1903 includes the functionalities of the SQL processing unit 1901, as illustrated in FIG. 19B.

The SQL processing unit 1901 processes a request for query processing sent from the client 105. The SQL processing unit 1901 includes an SQL analysis unit 1901a that analyzes SQL sent from the client 105 and creates requests for “GET” processing and “PUT” processing which are data manipulations in the KVS. The SQL analysis unit 1901a acquires information necessary for creating such the request with regard to the KVS, from the metadata management unit 1902 (described later). The SQL analysis unit 1901a may transfer a SQL query, received from the client 105, to the metadata management unit 1902, and the metadata management unit 1902 may create the request for a data manipulation in the KVS, based on the SQL query.

The SQL processing unit 1901 includes a request transfer unit 1901b. The request transfer unit 1901b transfers the request for a data manipulation in the KVS, created based on the SQL query, to the request management unit 1502. As described above, the SQL processing unit 1901 has functionality to convert an SQL query into a data manipulation in a KVS.

The metadata management unit 1902 includes a metadata storage 1902a. The metadata storage 1902a stores information used when an SQL query is converted into a request for a data manipulation in a KVS. Specifically, the metadata storage 1902a stores schema management information (described later) representing the schema (such as the structure of an RDB table) of a relational database manipulated by the SQL. In the schema management information, a specific element included in the relational database (element defined in the schema of the relational database) is associated with an encryption level. Specifically, such a specific element may be, for example, an RDB table included in a relational database, an attribute column and a record (row) included in the RDB table, a data element included in the attribute column or the record (row), and the like. The metadata management unit 1902 can provide the schema management information to the SQL processing unit 1901.

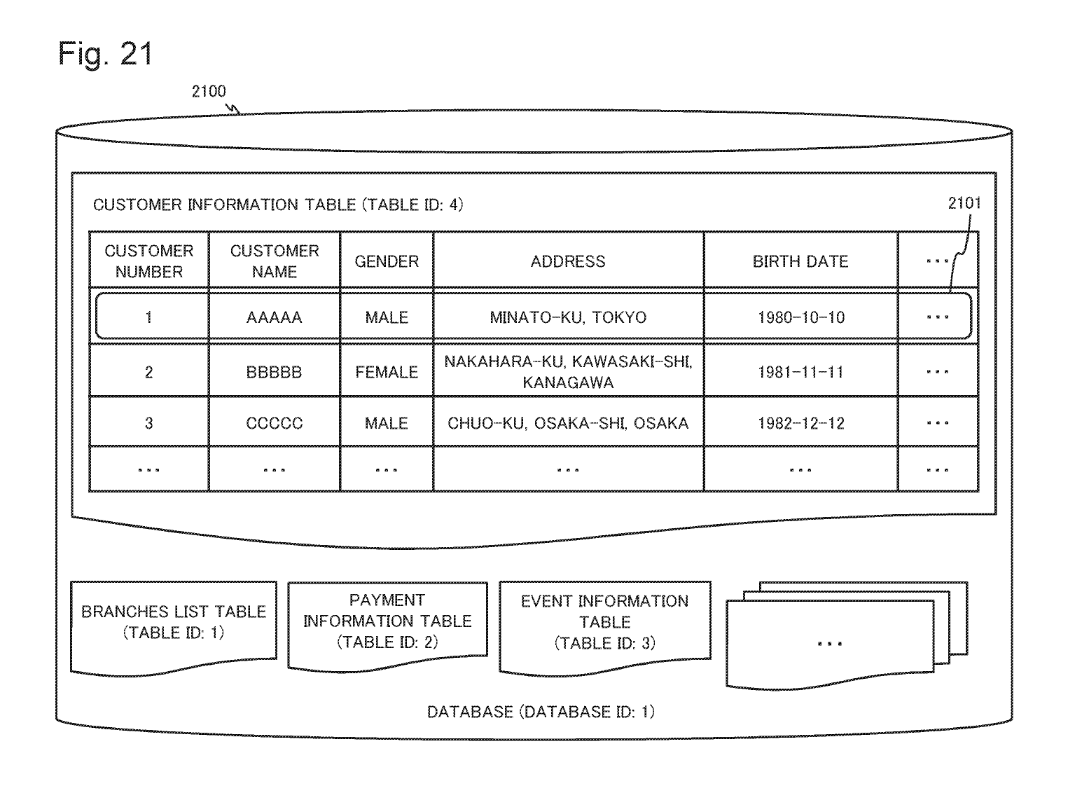

As a specific example for explanation, it is assumed below that the data management system 3 virtually provides a relational database 2100 having a schema as illustrated in FIG. 21 to the client 105. FIG. 21 illustrates one specific example for explanation, and the present example embodiment is not limited thereto.

The relational database 2100 illustrated in FIG. 21 includes plural RDB tables (branch list, payment information, event information, member information, and the like). Further, the member information table includes plural attribute columns (customer number, customer name, gender, address, birth date, and the like) and records (rows). The client 105 requests access to data stored in the relational database illustrated in FIG. 21, using SQL.

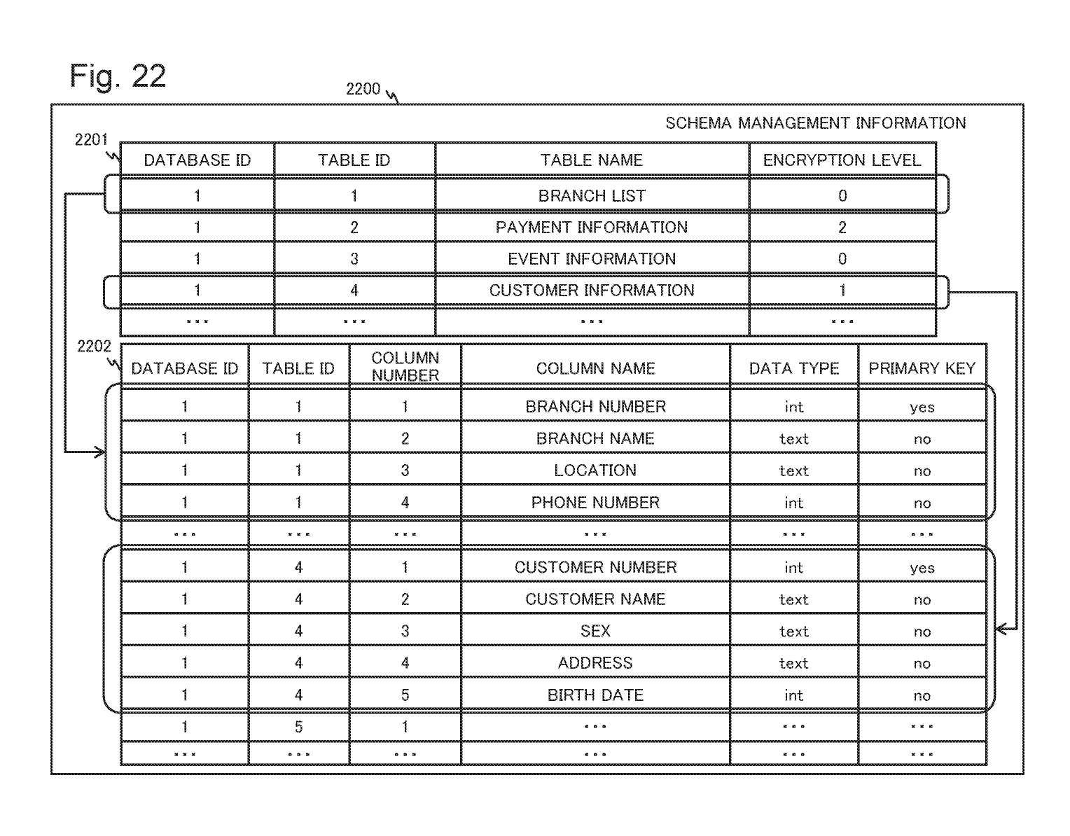

The metadata management unit 1902 (metadata storage 1902a) stores information representing the schema of the relational database 2100 with the use of such schema management information 2200 as illustrated in FIG. 22. In a specific example illustrated in FIG. 22, the schema management information 2200 includes first schema management information 2201 including information for specifying the RDB tables included in the relational database 2100. The schema management information 2200 includes second schema management information 2202 including the configuration of the RDB tables specified in the first schema management information 2201. The configuration illustrated in FIG. 22 is one specific example, and the present example embodiment is not limited thereto. For example, the first schema management information 2201 and the second schema management information 2202 may be merged, or may be divided into smaller units.

The following items are registered in the first schema management information 2201. That is, “database ID” and “table ID” are associated with each other, and registered in the first schema management information 2201. The “database ID” represents information for specifying the relational database 2100 and “table ID” represents information for specifying the RDB tables included in the database. Further, “table names” and “encryption levels” are associated with the table IDs, and registered in the first schema management information 2201. The “table names” represents the names of the RDB tables. The “encryption levels” is set according to the RDB tables respectively. The data management system 3 executes different cryptographic processing according the encryption levels, with regard to respective RDB tables. Data other than the above may be further registered in the first schema management information 2201.

The following items are registered in the second schema management information 2202. That is, the database IDs and the table IDs are associated with each other, and registered in the second schema management information 2202. In addition, column numbers for specifying the columns included in the RDB tables are associated with the table IDs, and registered in the second schema management information 2202. In addition, column name that represents the name of the column, data types that represents the kinds of data set in the columns, and primary KEY determination information that indicates whether the columns are primary KEYs, are associated with the column numbers, and registered in the second schema management information 2202. Data other than the above may be further registered in the second schema management information 2202.

The schema management information 2200 may be created in advance according to the schema of the relational database 2100 provided to the client 105.

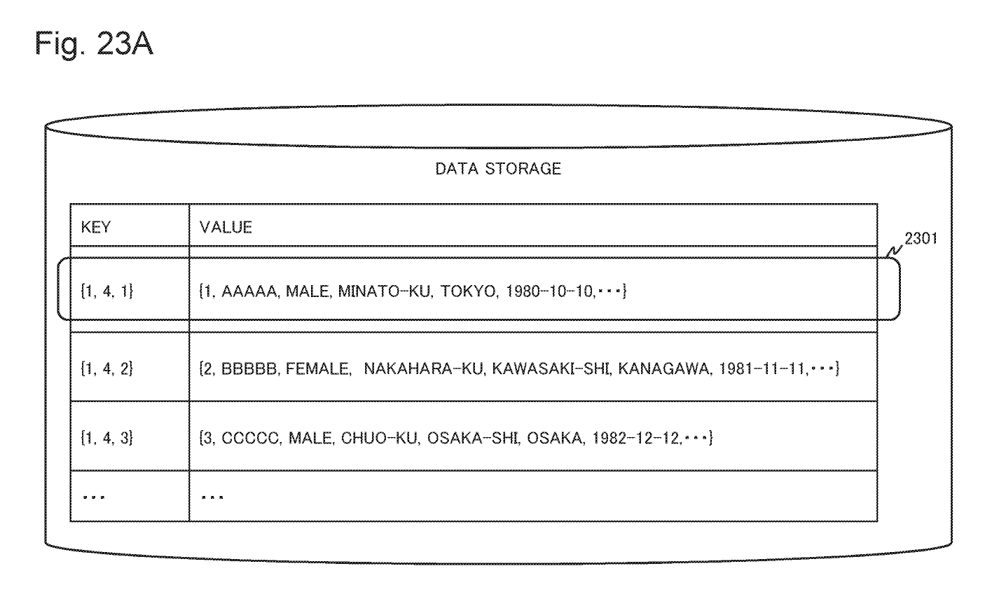

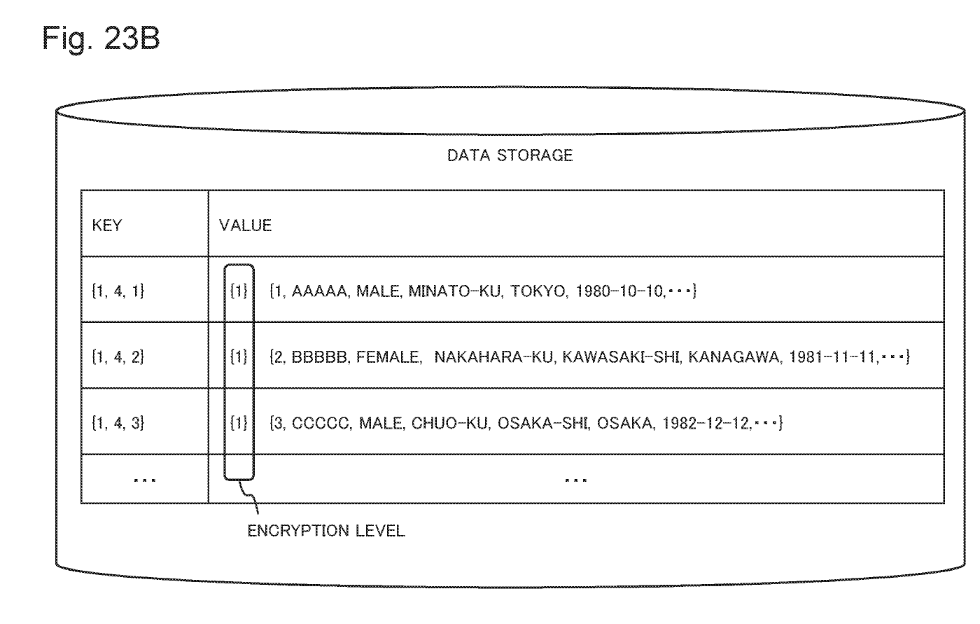

In such a specific example as described above, one example of data stored in the KVS managed by the data management unit 101 is illustrated in FIG. 23A. The data illustrated in FIG. 23A corresponds to data stored in “customer information table” in the relational database 2100. For example, a data set 2301 illustrated in FIG. 23A corresponds to a row 2101 in the customer information table in the relational database 2100 illustrated in FIG. 21. The KEY of the data set 2301 is {“1” (database ID), “4” (table ID), “1” (column number of primary KEY)}. The VALUE of the data set 2301 includes the data of each attribute column included in the row 2101. Specifically, data arranged in attribute columns in the row 2101 may be arranged in the VALUE of the data set 2301 in descending order of the column numbers of the attribute columns. In such a case, an attribute column, in the customer information table, in which each piece of data included in the VALUE of the data set 2301 is stored, can be identified using the column number of each attribute column. Like the second example embodiment described above, encryption levels may be included in the VALUEs of the data sets stored in the KVS in the present example embodiment, as illustrated in FIG. 23B.

Processing of a “GET” request and a “PUT” request in the request management unit 1903 will be described below. The request management unit 1903 can execute processing similar to that in the request management unit (102 or 1502) in each of the example embodiments described above.

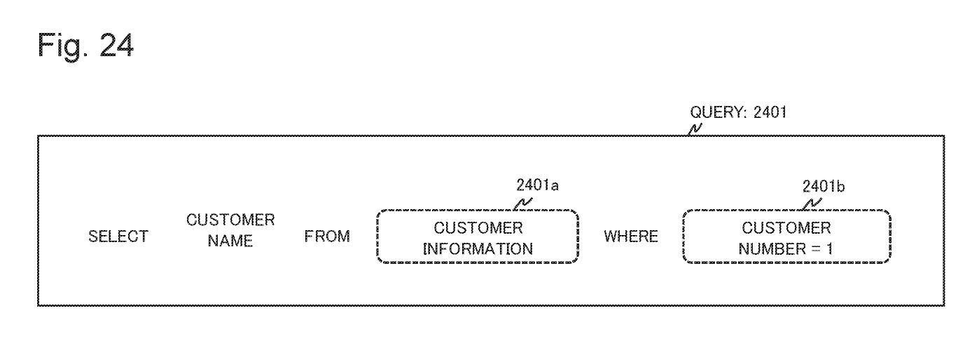

For an specific example, it is assumed a case where the SQL processing unit 1901 receives an SQL query 2401 illustrated in FIG. 24 from the client 105. It is also assumed that the client 105 selects and connects a database having an ID “1”. The database ID is omitted in the query illustrated in FIG. 24.

The SQL processing unit 1901 (SQL analysis unit 1901a) analyzes such a query, and extracts information used for creating a “GET” request for the KVS. In a specific example illustrated in FIG. 24, the SQL processing unit 1901 extracts, for example, a table name “customer information” (2401a in FIG. 24) and a condition “customer number=1” (2401b in FIG. 24). The SQL processing unit 1901 may extract these pieces of information from the SQL query based on, for example, an analysis rule defined in advance. A method of analyzing the SQL query can be implemented using a known technology (SQL parser or the like).

The SQL processing unit 1901 creates a KEY to be specified in a “GET” request for the KVS with reference to the schema management information 2200 provided by the metadata management unit 1902. The KEY includes the database ID 2001a, the table ID 2001b, and the primary KEY information 2001c, as illustrated in FIG. 20A.

For example, the SQL processing unit 1901 specifies the table ID “4” corresponding to the table name “customer information” from the first schema management information 2201. The SQL processing unit 1901 specifies that the encryption level associated with the table name “customer information” is “1”. The SQL processing unit 1901 identifies that the primary KEY in the table of the table ID “4” is “customer information”, from the second schema management information 2202. As a result, the SQL processing unit 1901 creates “{1, 4, 1}” as a KEY in the KVS.

The SQL processing unit 1901 creates a “GET” request for the KVS using the KEY, and sends the “GET” request to the request management unit 1903. The request management unit 1903 executes processing similar to that in the second example embodiment described above based on the “GET” request received from the SQL processing unit. In other words, the request management unit 1903 acquires a data set including the requested KEY from a data management unit 101. The request management unit 1903 acquires an encryption key associated with an encryption level included in the VALUE of the acquired data set from a key management unit 1504, and decrypts the VALUE.

When no encryption level is included in the data set stored in the KVS (FIG. 20A), the SQL processing unit 1901 may specify a specific encryption level in addition to the created KEY, and may send a “GET” request to the request management unit 1903. In such a case, the request management unit 1903 acquires, from the key management unit 1504, an encryption key associated with the encryption level specified in the “GET” request, and decrypts the VALUE.

The SQL processing unit 1901 receives the result of the processing of the “GET” request from the request management unit 1502. The SQL processing unit 1901 identifies the column number (“2” in this case) of “customer name” with reference to the second schema management information, and extracts the customer name (“AAAAA” arranged in the second from the head of the VALUE in this case) included in the VALUE. The SQL processing unit sends the extracted customer name as the result of the processing for the query to the client 105.

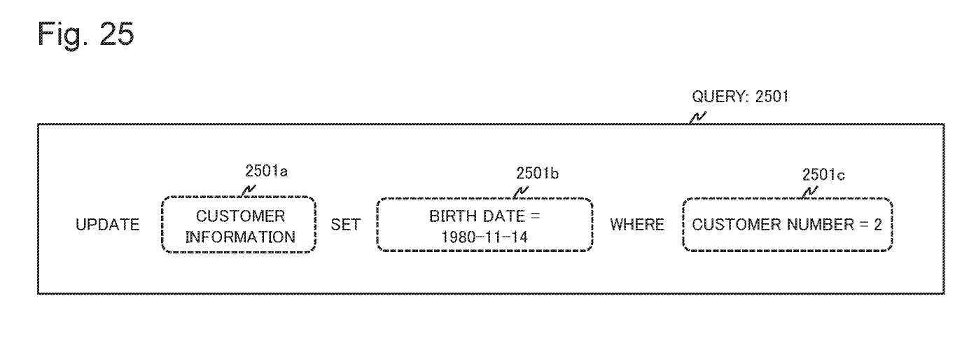

For example, it is assumed that the SQL processing unit 1901 receives an SQL query 2501 (FIG. 25) from the client 105. A database ID is omitted in the query 2501, and it is assumed that the database ID in this case is “1”.

The SQL processing unit 1901 (SQL analysis unit 1901a) analyzes the query, and extracts information used for creating a “PUT” request for the KVS. In a specific example illustrated in FIG. 25, the SQL processing unit 1901 extracts a table name “customer information” (2501a in FIG. 25), “birth date=1980-11-14” (2501b in FIG. 25), and “customer number=2” (2501c in FIG. 25).

The SQL processing unit 1901 creates a KEY specified in a “PUT” request for the KVS with reference to the schema management information 2200 provided from the metadata management unit 1902.

For example, the SQL processing unit 1901 specifies a table ID “4” corresponding to the database name “customer information” from the first schema management information 2201. The SQL processing unit 1901 specifies that an encryption level associated with the table name “customer information” is “1”. The metadata management unit 1902 specifies that a primary KEY in a table having the table ID “4” is “customer information”, from the second schema management information 2202. As a result, the SQL processing unit 1901 creates “{1, 4, 2}” as a KEY in the KVS.

The SQL processing unit 1901 creates a VALUE in which “birth date” of the data corresponding to the customer number “2” is set at “1980-11-14”. For example, the SQL processing unit 1901 sends a “GET” request to the request management unit 1903 using the KEY created as described above, and acquires the VALUE associated with the KEY. In such a case, for example, “{2, BBBBB, female, Nakahara-ku, Kawasaki-shi, Kanagawa, 1981-11-11, . . . }” is acquired as the VALUE. The SQL processing unit 1901 updates a field corresponding to “birth date” included in the VALUE, to “1980-11-14”. The SQL processing unit 1901 may specify the field with reference to, for example, a column number “5” in “birth date” in the second schema management information. A method of creating the VALUE is not limited to the above. The SQL processing unit 1901 may adopt another appropriate method. The SQL processing unit 1901 inserts the encryption level (“1” in this case) specified as described above into the VALUE created as described above.

The SQL processing unit 1901 creates a “PUT” request for the KVS using the KEY and VALUE created as described above, and sends the “PUT” request to the request management unit 1903. The request management unit 1903 executes processing similar to that in the second example embodiment described above, based on the “PUT” request received from the SQL processing unit. In other words, the request management unit 1903 acquires, from the key management unit 1504, an encryption key associated with an encryption level included in the VALUE specified in the “PUT” request, and encrypts the VALUE. The request management unit 1903 specifies the KEY and the encrypted VALUE, and sends a “PUT” request to the data management unit 101. The SQL processing unit 1901 may insert the encryption level into the encrypted VALUE. In such a case, for example, such data as illustrated in FIG. 23B is stored in the KVS managed by the data management unit 101. Unless the encryption level is inserted into the encrypted VALUE, such data as illustrated in FIG. 23A is stored in the KVS managed by the data management unit 101.

The processing described above enables the data management system 3 to execute cryptographic processing of different encryption level, according to RDB tables, respectively. This is because in the data management system 3, the individual encryption levels are set for each of the RDB tables respectively, and the cryptographic processing according to the encryption levels is executed when processing t “GET” request and a “PUT” request based on an SQL query.

Like each of the example embodiments described above, the data management system 3 uses individual encryption keys associated with respective partitions into which the KVS is divided, to encrypt data sets included in the partitions. Even when large amount of data are included in the RDB tables, the data management system 3 can distribute and store the data into the plural partitions in the KVS.

The encryption levels described above are set for each of the partitions respectively. When higher security levels are needed in tables included in a relational database, the data management system 3 may use the encryption key of higher encryption level among encryption keys that are are associated with the respective partitions. As a result, even when large amount of data are included in the table requiring the higher security level, the data management system 3 can distribute a load required for cryptographic processing of the data. Specifically, the data management system 3 can distribute the load required for re-encryption of the data. Thus, the data management system 3 can achieve both of the distribution of the load for the cryptographic processing and the improvement of a security level.

Further, the data management system 3 can provide transparent cryptographic processing similar to that in each of the example embodiments described above to the client 105 issuing an SQL query.

### Alternative Example of Third Example Embodiment

In the following, an alternative example in which a part of the third example embodiment is changed will be described. In the third example embodiment described above, the individual encryption levels are set according to the RDB tables respectively, in the schema management information 2200. In a data management system 3 in the present alternative example, encryption levels can be individually set according to respective columns included in RDB tables in a relational database.

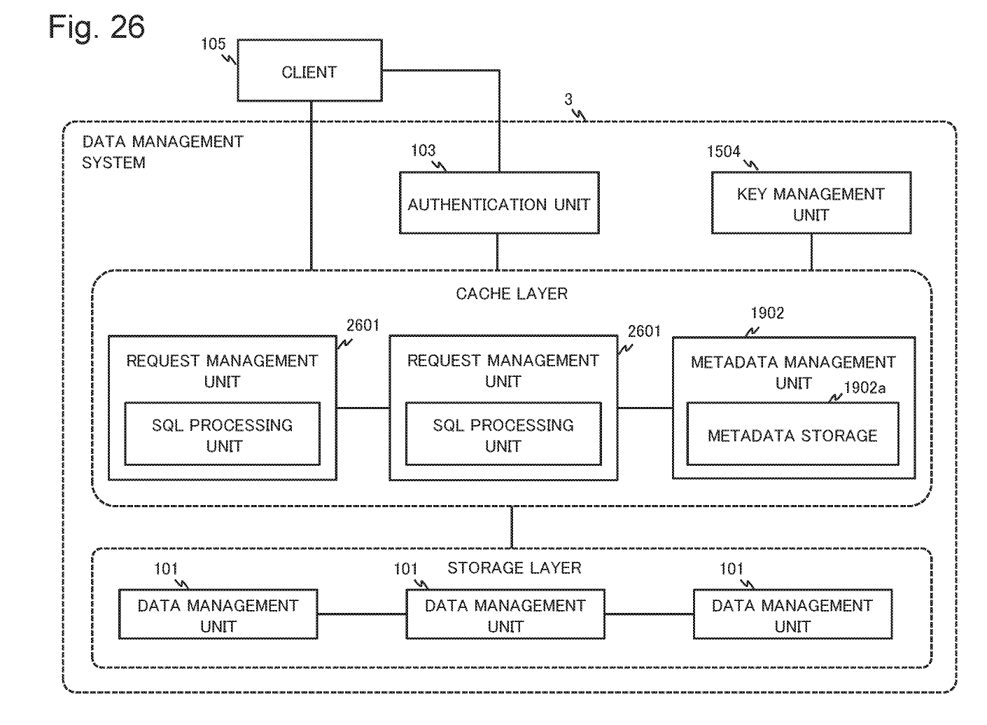

FIG. 26 is a block diagram illustrating the functional configuration of the data management system 3 in the present alternative example. In the present alternative example, it is assumed that a request management unit 2601 includes functionalities equivalent to those of the SQL processing unit 1901 in the third example embodiment. The present alternative example is not limited thereto. Like the third example embodiment described above, the request management unit 2601 and an SQL processing unit may be separated from each other.

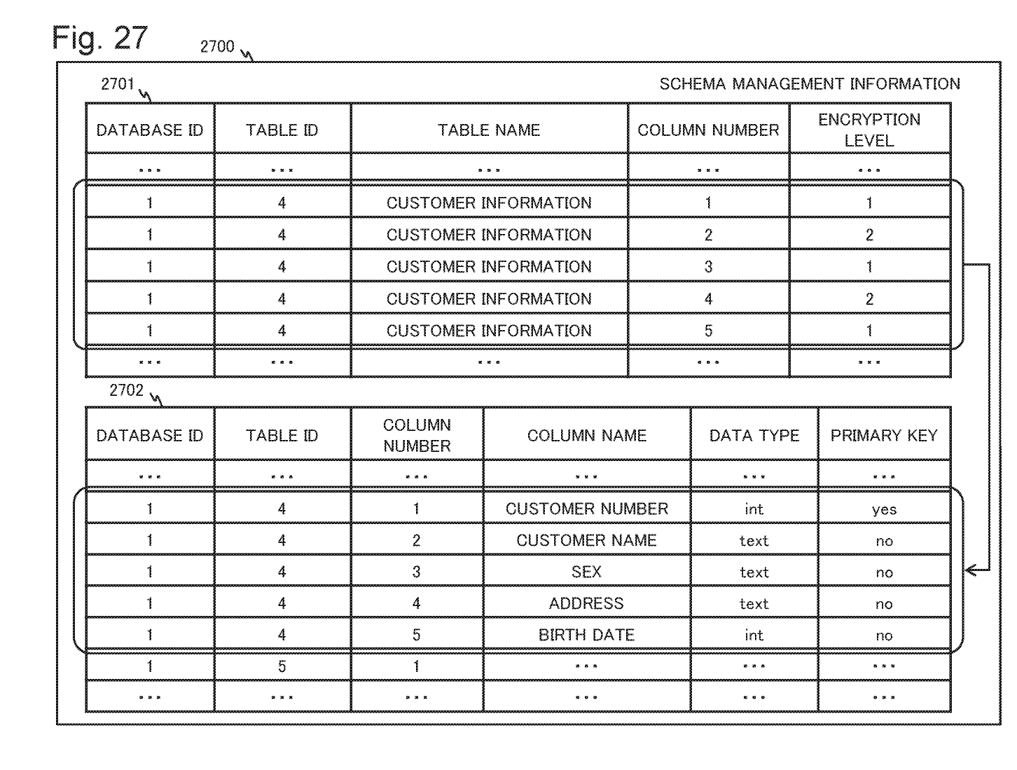

Descriptions will be given below with reference to a specific example. In the data management system 3 in the present alternative example, individual encryption levels are set according to respective columns included in RDB tables (for example, “customer information tables”) in a schema management information 2700, as illustrated in FIG. 27.

In such a case, the request management unit 2601 specifies columns (column numbers) in which respective pieces of data included in the VALUEs of data sets are arranged in the RDB tables of a relational database. With reference to encryption levels associated with the specified column numbers, the request management unit 2601 acquires encryption keys corresponding to the encryption levels from a key management unit 1504. The request management unit 2601 uses the acquired encryption keys to execute cryptographic processing (encryption or decryption) using the individual encryption keys according to the respective pieces of data included in the VALUEs.

As a result, the data management system 3 in the present alternative example can provide the encryption levels differing according to the respective columns of the relational database. In other words, when the significances of pieces of data stored in the columns of the relational database differ according to the respective columns, the encryption levels can be varied according to the significances of the respective pieces of data, in the data management system 3 in the present alternative example.

The data management system 3 in the present alternative example can set, for example, individual encryption levels according to respective partial areas into which the RDB tables are logically divided. Specifically, the data management system 3 divides (partitions) an RDB table into plural logical partial areas based on data stored in a specific column in the RDB table, and sets different encryption levels according to the divided partial areas, respectively. Hereinafter, the partial areas into which the tables are partitioned are referred to as “database partitions” in order to distinguish the partial areas from partitions in a KVS.

Specifically, for example, on the basis of whether or not data stored in a specific column in an RDB table satisfies a predetermined condition, the data management system 3 may partition the RDB table. For one specific example, the condition may be a condition relating to the range of the possible values of the data stored in the specific column in the RDB table. For another example, the condition may be a condition representing whether or not the data stored in the specific column is included in a particular data set (for example, list of data satisfying particular condition).

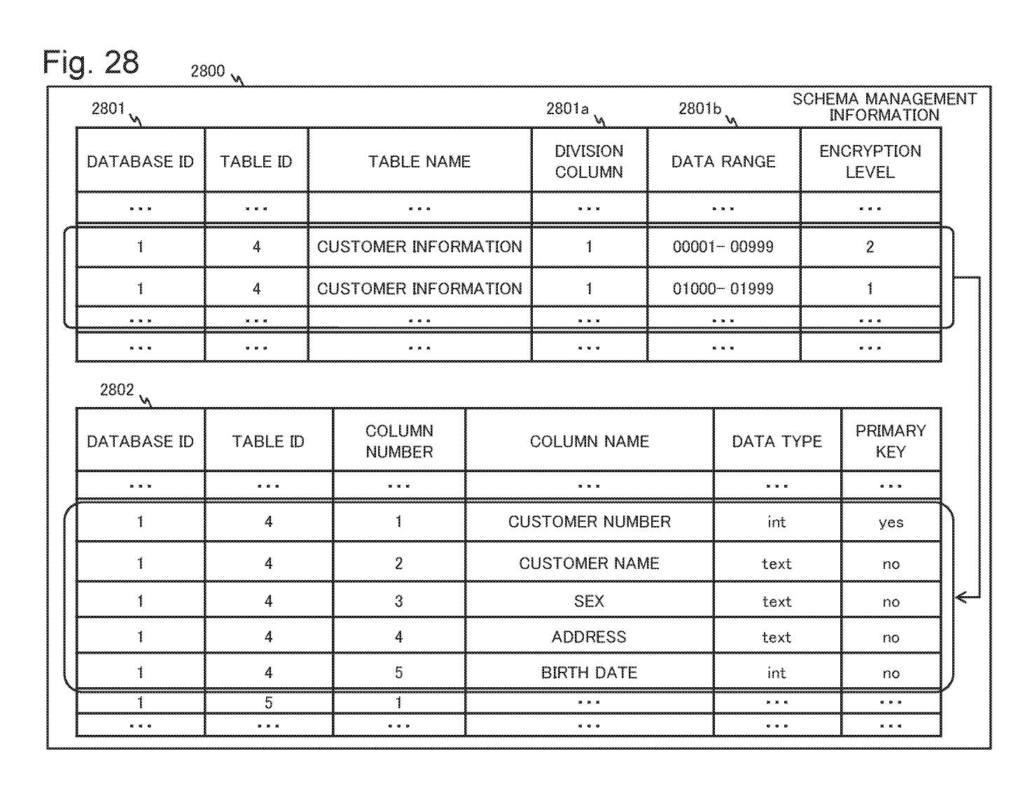

In the following, as one specific example, it is assumed that a customer information table included in a relational database 2100 is divided into plural database partitions based on the value of “customer number”. In the specific example illustrated in FIG. 28, the number of the column used in the partitioning (in this case, “1” corresponding to “customer number”) is set as the division column (2801a in FIG. 28) in the first schema management information 2801. The range of the data of a division column assigned to one database partition is set to a data range (2801b in FIG. 28) in the first schema management information 2801. In the specific example illustrated in FIG. 28, the customer information table is divided into database partitions based on the range of customer numbers. Without limitation to the above, the data management system 3 may divide the customer information table into database partitions based on, for example, whether or not a customer number is included in a particular data set (for example, separately defined list of customer numbers having high importance). In the specific example illustrated in FIG. 28, encryption levels are set according to the respective ranges of the database partitions (for example, respective partial areas into which RDB tables are logically divided).

In this case, the request management unit 2601 specifies columns (column numbers) in which respective pieces of data included in the VALUE of the data set are arranged in the RDB tables, with reference to the first schema management information 2801. As a result, the request management unit 2601 can identify the data of the division column included in the VALUE. The request management unit 2601 identifies the encryption level associated with a range of the division data included in the VALUE, with reference to the first schema management information 2801. The request management unit 2601 acquires encryption keys corresponding to the specified encryption level from the key management unit 1504. The request management unit 2601 executes cryptographic processing (encryption or decryption) for the VALUE using the acquired encryption keys. As a result, the data management system 3 in the present alternative example can provide the different encryption levels according to database partitions into which the database is logically divided. In other words, when the importance of stored data is different according to the respective database partitions, the encryption level can be varied according to the importance of the respective database partitions, in the data management system 3 in the present alternative example.

### Fourth Example Embodiment

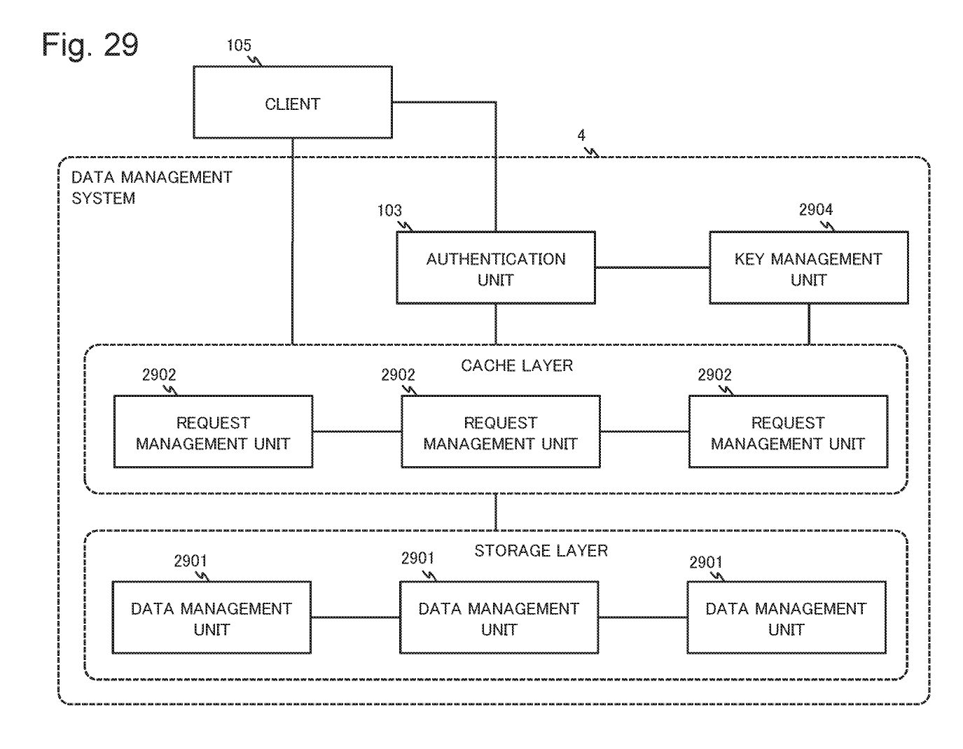

A fourth example embodiment of the present disclosure will be described below. FIG. 29 is a block diagram illustrating the functional configuration of a data management system 4 in the present example embodiment. The functional configuration illustrated in FIG. 29 is one specific example. One or more components may be merged, or each component may be further divided. Arrangement of each component may be changed as appropriate as long as similar functionalities can be achieved. The present example embodiment may be merged with each of the example embodiments described above as appropriate.

The data management system 4 can achieve functionality similar to that of any of the data management system 1 to the data management system 3 in each of the example embodiments described above. Further, a data management unit 2901, a request management unit 2902, and a key management unit 2904 in the data management system 4 can achieve functionalities similar to the functionalities of the components of any of the data management system 1 to the data management system 3 in the example embodiments described above.

A partition in a KVS corresponds to one area of an arrangement ring being divided into plural areas, as described above. The data management system 4 in the present example embodiment re-divides the arrangement ring which is already divided into plural partitions, further into plural partitions. Specifically, the data management system 4 in the present example embodiment can dynamically re-divide the partitions in the KVS without executing re-encryption processing for data sets included in the partitions.

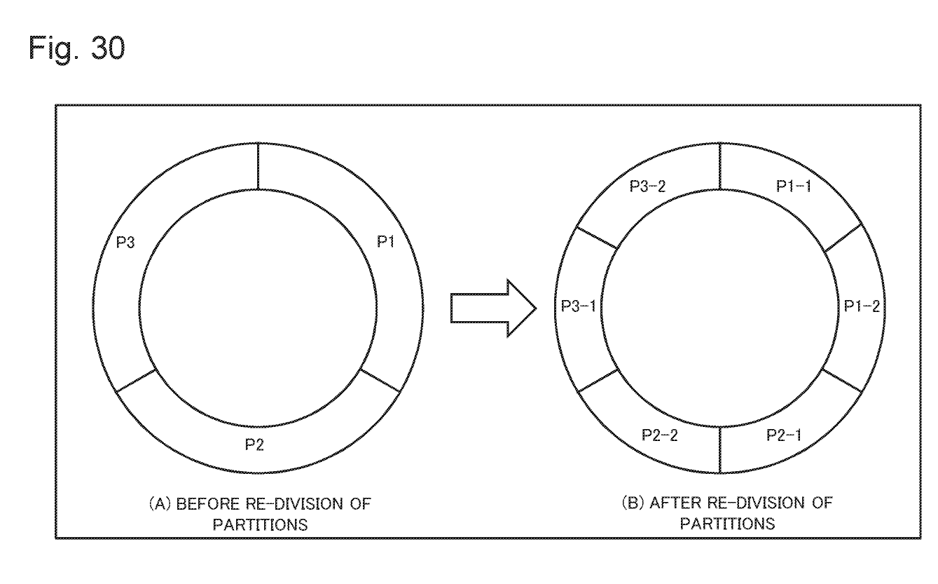

The re-division of the partitions, executed by the data management system 4, will be described with reference to a specific example illustrated in FIG. 30. FIG. 30 illustrates one specific example for description. The present example embodiment is not limited thereto.

The data management system 4 divides an arrangement ring (part (A) in FIG. 30) before the division, further into plural areas (part (B) in FIG. 30). As a result, three partitions (“P1” to “P3”) are divided into six partitions (“P1-1” to “P3-2”) in the specific example illustrated in FIG. 30.

For example, the request management unit 2902 in the data management system 4 detects an appropriate trigger (detecting that, for example, the total number of data stored in the KVS is more than particular criterion), and executes the re-division of the partitions. In such a case, the request management unit 2902 determines, for example, the number of the partitions after the re-division, and an assignment of each re-divided partition to the data management unit 2901, as appropriate, based on settings, predetermined criteria, and the like.

When a node (data management unit 101) that manages the partitions before the re-division and a node that manages the partitions after the re-division are different from each other, some pieces of data are transferred from the node that manages the partitions before the division to the node that manages the partitions after the division. The division of the partitions and the re-assignment of the nodes can be processed in a manner similar to that in processing of adding a node in a known KVS.

When the partitions are re-divided, the key management unit 2904 in the present example embodiment associates encryption keys associated with the partitions before the division with the new partitions after the division, into which the partitions are divided. The key management unit 2904 sets new expiration dates to the respective encryption keys being assigned to the new partitions after the division. The expiration dates newly set to the encryption keys being assigned to the re-divided partitions are different from the expiration dates of the encryption keys associated with the partitions before the re-division. That is, the key management unit 2904 sets new expiration dates to the encryption keys for re-divided partitions, which are respectively different from expiration dates for encryption keys for partitions before re-division.

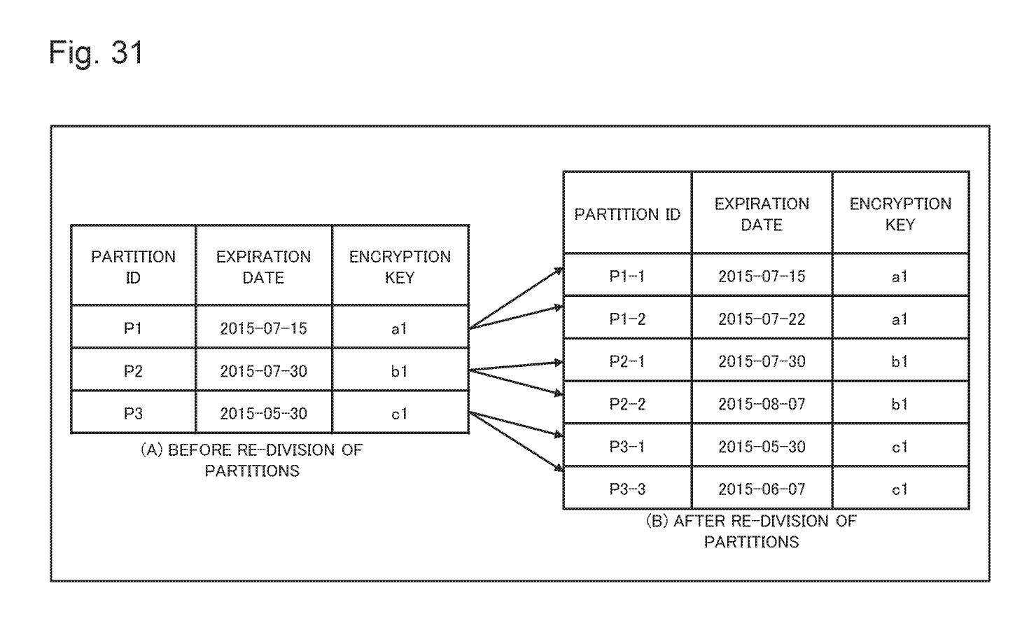

For example, in a specific example illustrated in FIG. 31, the key management unit 2904 associates an encryption key (“a1”) being associated with a partition “P1” before the division, with partitions “P1-1” and “P1-2” after the division. Further, the key management unit 2904 sets different expiration dates (“2015-07-15” and “2015-07-22”) to the encryption keys associated with the partitions “P1-1” and “P1-2” after the re-division. The key management unit 2904 operates similarly with regard to the other partitions (“P2” and “P3”).

As described above, it is not necessary to update the encryption keys at the timing of re-dividing the partitions. Therefore, the request management unit 2902 need not execute re-encryption processing for data sets included in the partitions before the division. In other words, the data management system 4 in the present example embodiment can re-divide the partitions without causing an additional processing load for re-encryption processing of the data sets included in the re-divided partitions.

In addition, according to the present example embodiment, different expiration dates are respectively set to encryption keys associated with new partitions after the division. Therefore, such encryption keys are updated at different timings. In other words, the encryption keys associated with the new partitions after the division are updated at the different timings, thereby become different encryption keys, respectively. Thus, the data management system 4 in the present example embodiment can re-divide partitions, then encrypting data sets included in the partitions using different encryption keys according to the partitions, respectively.

Therefore, the data management system 4 can change the number of partitions (re-divides partitions) according to an increase in data sets stored in the KVS during operation of the system, whereby the number of encryption keys for encrypting data sets can be changed. Consequently, in the data management system 4, for example, it is not necessary to preliminary determine the number of encryption keys in advance based on, for example, the predicted value of the number of the data sets stored in the KVS. The number of the encryption keys can be changed appropriately, according to an increase in the data sets.

### Fifth Example Embodiment

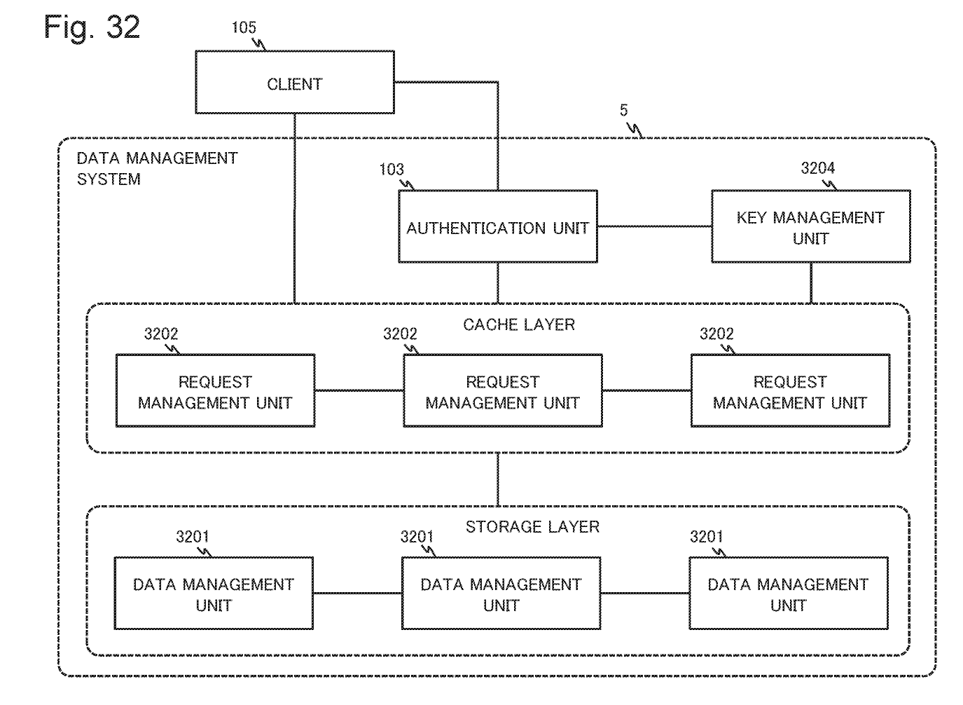

A fifth example embodiment of the present disclosure will be described below. FIG. 32 is a block diagram illustrating the functional configuration of a data management system 5 in the present example embodiment. The functional configuration illustrated in FIG. 32 is one specific example. One or more components may be merged, or each component may be further divided. Arrangement of each component may be changed as appropriate as long as similar functionalities can be achieved. The present example embodiment may be combined with each of the above-described example embodiments as appropriate.

The data management system 5 can achieve functionality similar to that of any of the data management system 1 to the data management system 4 in each of the example embodiments described above. A data management unit 3201, a request management unit 3202, and a key management unit 3204 in the data management system 5 can achieve functionalities similar to the functionalities of the components of any of the data management system 1 to the data management system 4 in the example embodiments described above.

The data management system 1 to data management system 4 in the respective example embodiments described above, mainly encrypt the VALUEs of data sets stored in a KVS. The data management system 5 in the present example embodiment can encrypt the KEYs of the data sets stored in the KVS, in addition to above.

When a KEY included in a data set is simply encrypted, such problems, as described below, can occur. That is, specifically, when a KEY is encrypted using an encryption key, a hash value calculated using an unencrypted KEY and a hash value calculated using an encrypted KEY can be different from each other. In other words, a data set including the unencrypted KEY and a data set including the encrypted KEY can be assigned to different partitions.

In addition, when an encryption key used for encrypting the KEY, the values of a KEY encrypted by the encryption key before updating and values of a KEY encrypted by the encryption key after the updating are different from each other. Thus, hash values calculated using the values can be different from each other. In other words, a data set including the KEY encrypted using the encryption key before the updating and a data set including the KEY encrypted using the encryption key after the updating can be assigned to different partitions.

When a KEY included in a data set is encrypted simply as described above, a partition including the data set including the KEY is changed according to change of an encryption key. As a result, for example, data sets including the same particular KEY can be included in different partitions. For example, when a data set is stored in a particular partition and then the encryption key used for encrypting the KEY of the data set is updated, there is a possibility that the data set stored in the partition cannot be accessed.

In order to solve such problems, the data management system 5 in the present example embodiment calculates the hash value of a data set stored in a KVS using a KEY before encryption. The data management system 5 specifies a partition including the data set by this way, and encrypts the KEY and a VALUE when storing the KEY and the VALUE in the specified partition. In other words, the data management system 5 in the present example embodiment uses the KEY before the encryption to specify the partition of the KVS in which the data set including the KEY is stored. The data management system 5 encrypts and stores the KEY and the VALUE when the data set is actually stored in the partition of the KVS.

Processing in the data management system 5 will be specifically described below. Like the first example embodiment described above, the request management unit 3202 specifies a partition in which a data set including a requested KEY is stored, when receiving a “GET” request from a client 105. Specifically, for example, the request management unit 3202 calculates the hash value of the requested KEY, and specifies the partition assigned with the hash value. In such a case, the request management unit 3202 calculates the hash value of the KEY before encryption. The request management unit 3202 can specify a data management unit 3201 that manages the partition specified as described above.

The request management unit 3202 sends the requested KEY to the key management unit 3204, and acquires an encryption key from the key management unit 3204. In such a case, the key management unit 3204 uses the hash value of the KEY before the encryption to specify the partition in which the data set including the KEY is stored. The key management unit 3204 sends the encryption key associated with the specified partition to the request management unit 3202.

The request management unit 3202 encrypts the requested KEY using the encryption key acquired from the key management unit 3204. The request management unit 3202 specifies the encrypted KEY, and sends a “GET” request to the data management unit 3201 specified as described above.

The data management unit 3201 retrieves a VALUE associated with the requested KEY (that has been encrypted). The data management unit 3201 sends the acquired VALUE to the request management unit 3202. Other processing for the “GET” request may be similar to that in the first example embodiment described above.

Like the first example embodiment described above, the request management unit 3202 specifies a partition in which a data set including the requested KEY is stored, when receiving a “PUT” request from the client 105. Specifically, for example, the request management unit 3202 calculates the hash value of the requested KEY, and specifies the partition assigned with the hash value. In such a case, the request management unit 3202 calculates the hash value of a KEY before encryption. The request management unit 3202 can specify a data management unit 3201 that manages the partition specified as described above.

The request management unit 3202 sends the requested KEY to the key management unit 3204, and acquires an encryption key from the key management unit 3204. In such a case, the key management unit 3204 uses the hash value of the KEY before the encryption to specify the partition in which the data set including the KEY is stored. The key management unit 3204 sends the encryption key associated with the partition to the request management unit 3202.

The request management unit 3202 encrypts the requested KEY and the VALUE using the encryption key acquired from the key management unit 3204. The request management unit 3202 sends a “PUT” request including the encrypted KEY and VALUE to the data management unit 3201 specified as above. Other processing for the “PUT” request may be similar to that in the first example embodiment described above.

The data management system 5 configured as described above can encrypt and store not only the VALUE but also the KEY included in the data set, in the KVS. In addition, in the data management system 5, even when an encryption key for encrypting a KEY is changed, a partition in which a data set including the KEY is stored is not changed. This is because the data management system 5 uses a hash value calculated from the KEY before encryption to specify the partition in which the data set including the KEY is stored.

### Sixth Example Embodiment

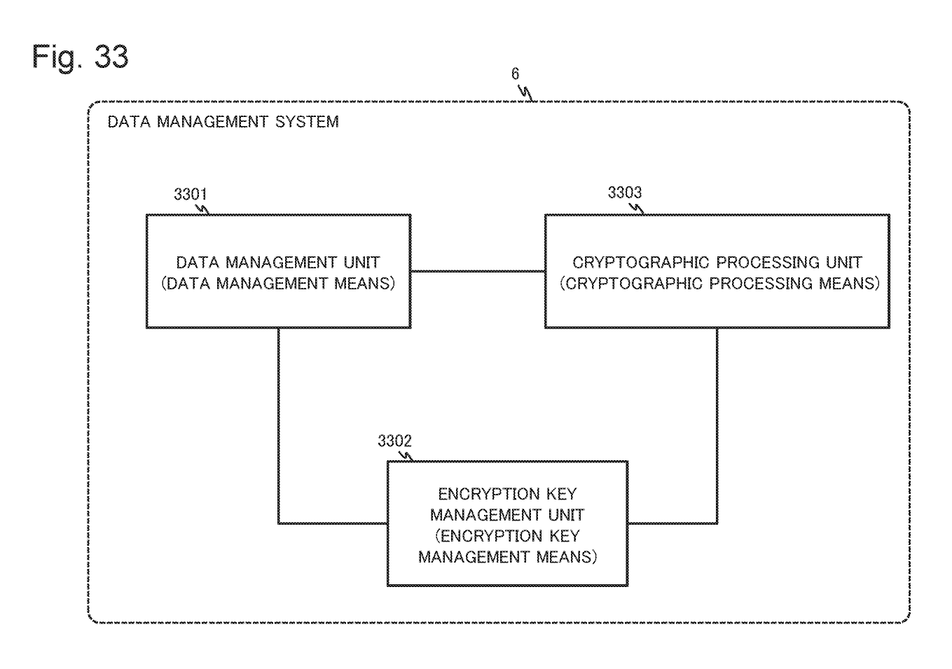

A sixth example embodiment which is a basic example embodiment of the present disclosure described in each of the example embodiments described above will be described below. FIG. 33 is a block diagram illustrating the functional configuration of a data management system 6 in the present example embodiment.

The data management system 6 in the present example embodiment includes a data management unit 3301, an encryption key management unit 3302, and an cryptographic processing unit 3303. These components in the present example embodiment are connected to each other so that communication can be carried out by an appropriate communication method.

The data management unit 3301 divides a table of a database into plural partitions, and manages the partitions based on data included in a specific column included in the table in the database. The database may be implemented by, for example, the KVS as described above, a relational database, and the like.

The data management unit 3301 can implement, for example, the functionalities of at least some of the request management units (101, 1502, 1903, 1601, 2901, and 3201) and the data management units (101, 2901, and 3201) in the respective example embodiments described above. Hereinafter, the request management units (101, 1502, 1903, 1601, 2901, and 3201) in the respective example embodiments described above are collectively referred to as “request management units”. Further, the data management units (101, 2901, and 3201) in the respective example embodiments described above are collectively referred to as “data management units”. The data management unit 3301 may include, for example, components that achieve functionalities of at least part of the components included in the request management units and the data management units, in the respective example embodiments described above.

Key management unit 3302 stores individual encryption keys by associated them with the respective partitions described above. The encryption key management unit 3302 can achieve, for example, the functionalities of at least part of the key management units (104, 1504, 2904, and 3204, hereinafter collectively referred to as “key management units”), in the respective example embodiments described above. The encryption key management unit 3302 may include, for example, components that achieve functionalities of at least part of the components included in the key management units, in the respective example embodiments described above.

The cryptographic processing unit 3303 uses the encryption keys associated with the respective partitions to execute cryptographic processing for data included in the partitions. The cryptographic processing includes, for example, processing of encrypting data included in a particular partition, and processing of decrypting the encrypted data. The cryptographic processing unit 3303 can realize, for example, the functionalities of at least some of the request management units and the key management units in the respective example embodiments described above. The cryptographic processing unit 3303 may include, for example, components that can realize functionalities of at least part of the components included in the data management units and the key management units, in the respective example embodiments described above.

On the basis of data included in a specific column included in a table in a database, the data management system 6 in the present example embodiment divides the table into plural partitions. As a result, the data management system 6 in the present example embodiment is able to divide a database into partial areas (for example, partitions) having an appropriate granularity. In addition the data management system 6 in the present example embodiment can store individual encryption keys by associating them with the divided respective partitions respectively. Consequently, the data management system 6 in the present example embodiment is able to execute cryptographic processing respectively for the divided respective partitions. As described above, the data management system 6 in the present example embodiment is able to divide a database into partial areas (for example, partitions) having an appropriate granularity, and to execute cryptographic processing respectively for the divided respective areas.

With regard to the present disclosure described with reference to each of the example embodiments described above, there are following situations. That is, according to recent increase of data stored in data management systems (for example, various databases and the like) managing various kinds of data, the significance of the data has increased. In such a situation, demand for protecting data stored in the data management systems also increases. A method of encrypting data stored in a data management system is known as one of methods for protecting data.

When data stored in a data management system is encrypted with a common encryption key, a risk in a case of a leakage of the common encryption key becomes high. In addition, a processing cost required for re-encrypting the stored data is high when the common encryption key is changed. To deal with this, for example, a database system in which individual encryption keys are used according to respective tables included in a database may be used.

For example, the sizes, amounts, or degrees of confidentiality of data stored in tables included in a database differ according to data stored in the tables in a data management system. That is, the cost of cryptographic processing, or a risk in a case of a leakage an encryption key varies according to data stored in the tables. Thus, assigning individual encryption keys on units (granularities) of tables may be inappropriate from the viewpoint of reducing a risk caused by leakage of an encryption key, or from the viewpoint of distribution of a load caused by cryptographic processing. With regard to this problem, for example, the technologies of the respective literatures described in the background art are not able to solve such problems.

In contrast, the example embodiments described in the present disclosure are able to execute cryptographic processing individually, for respective partial areas (for example, partitions of tables) into which a database is divided to be appropriate granularity.

<Configurations of Hardware and Software Program (Computer Program)>

A hardware configuration that can achieve each of the example embodiments described above will be described below.

In the following description, the data management systems (1 to 6) described in the respective example embodiments described above are collectively simply referred to as “data management systems”. Further, each component included in the data management systems is simply referred to as “component of data management system”.

The data management system described in each of the example embodiments described above may include one or plural dedicated hardware apparatuses. In such a case, the corresponding components described in each of the above-described figures (FIG. 2, Feig. 3, FIG. 15, FIG. 19A, FIG. 19B, FIG. 26, FIG. 29, FIG. 32, and FIG. 33) may be implemented using hardware in which some or all of the components are integrated (e.g., integrated circuit or storage device equipped with processing logic).

When the data management system is implemented by the dedicated hardware, the components of the data management system may be implemented using, for example, circuitry (for example, integrated circuit such as system on a chip (SoC)) capable of providing the functionality of each component. In such a case, data stored in the components of the data management system may be stored in, for example, a random access memory (RAM) area or flash memory area unified as a SoC, or a storage device (semiconductor storage apparatus or the like) connected to the SoC. In such a case, a well-known communication bus may be adopted as a communication line that connects the components of the data management system to each other. Further, the communication line that connects the components to each other is not limited to the bus connection, but the components may be connected to each other in a peer-to-peer manner. When the data management system is configured with plural hardware apparatuses, the hardware apparatuses may be communicatively connected to each other by an appropriate communication method (wired communication, wireless communication, or communication method in combination thereof).

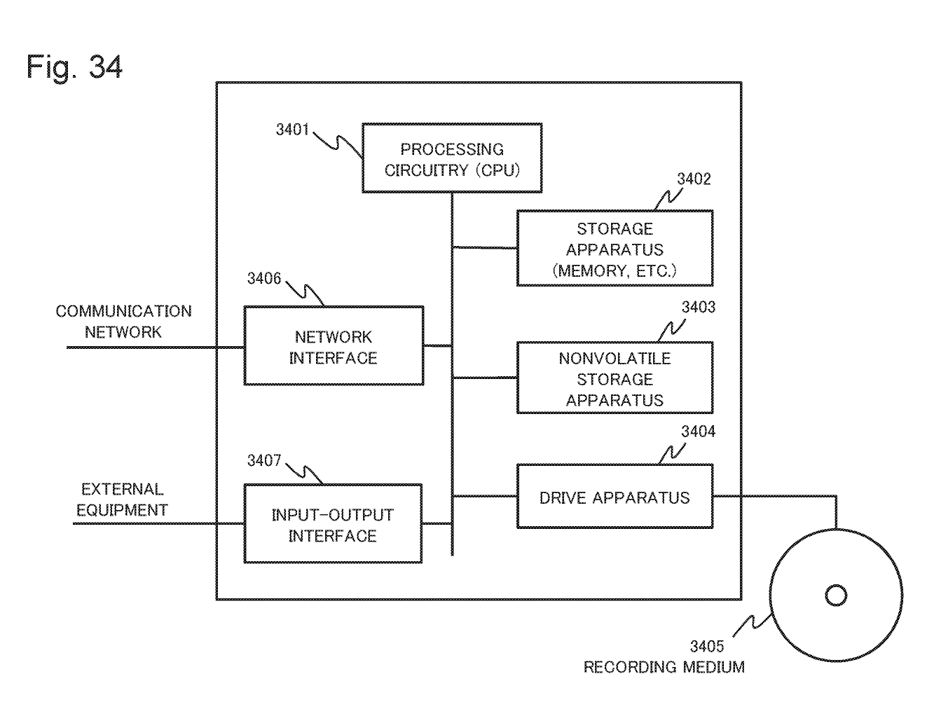

The data management system described above or the components thereof may be configured with general-purpose hardware illustrated in FIG. 34 and various software programs (computer programs) that are executed by the hardware. In such a case, the data management system may be configured with one or more general-purpose hardware apparatuses and one or more software programs, of which the numbers are appropriate. In other words, individual hardware apparatuses may be assigned to respective components included in the data management system, or plural components may be implemented using one hardware apparatus.

A processing circuitry 3401 in FIG. 34 is a processor such as a general-purpose central processing unit (CPU) or a microprocessor. The processing circuitry 3401 may read, for example, various software programs stored in nonvolatile storage apparatus 3403 described later, into a storage apparatus 3402, to execute processing according to the software programs. For example, the components of the data management system in each of the example embodiments described above may be implemented as software programs executed by the processing circuitry 3401.

The storage apparatus 3402 is a memory device such as RAM, which is configured to be accessible from the processing circuitry 3401. Software programs, various pieces of data, and the like may be stored in the storage apparatus 3402. The storage apparatus 3402 may be a volatile memory apparatus.

The nonvolatile storage apparatus 3403 is, for example, a nonvolatile storage apparatus such as a magnetic disk drive or a semiconductor storage apparatus with flash memory. Various software programs, data, and the like can be stored in the nonvolatile storage apparatus 3403.

A network interface 3406 is an interface apparatus connected to a communication network. For example, an interface apparatus for wired or wireless local area network (LAN) connection, an interface apparatus for SAN connection, and the like may be adopted as the network interface 3406.

A drive apparatus 3404 is, for example, an apparatus that processes reading and writing of data for a recording medium 3405 described later.

The recording medium 3405 is, for example, a recording medium in which data can be recorded, such as an optical disk, a magneto-optical disk, or semiconductor flash memory.

An input-output interface 3407 is an apparatus that controls input from and output to an external apparatus.

The data management system (or components thereof) in the present disclosure, described by each of the example embodiments described above as examples, may be implemented by, for example, supplying software programs that can implement the functionalities described in each of the example embodiments to the hardware apparatuses illustrated in FIG. 34. More specifically, the processing circuitry 3401 may execute the software programs supplied to the apparatuses, thereby achieving the present disclosure. In such a case, an operating system in such a hardware apparatus, middleware such as database management software, network software, or a virtual environment platform, or the like may execute part of processing.

In each of the example embodiments described above, each of the above-described units illustrated in each figure can be implemented as a software module which is a unit of the functionality (processing) of a software program executed by the hardware described above. However, the divisions of the modules illustrated in the drawings are configurations for convenience in description, and various configurations can adoptable for implementation.

When the corresponding components of the data management systems illustrated in FIG. 2, FIG. 3, FIG. 15, FIG. 19A, FIG. 19B, FIG. 26, FIG. 29, FIG. 32, and FIG. 33 are implemented as software modules, for example, the software modules are stored in the nonvolatile storage apparatus 3403. The software modules are load into the storage apparatus 3402 when the processing circuitry 3401 executes respective pieces of processing.

The software modules may be configured to be able to transfer various data to each other, by an appropriate method such as common memory or interprocess communication. Such configurations enable the software modules to be connected communicatively to each other.

In addition, the software programs described above may be recorded in the recording medium 3405. In such a case, the software programs described above may be configured to be stored in the nonvolatile storage apparatus 3403 via the drive apparatus 3404 as appropriate in the shipment stages, operation stages, and the like of the data management systems described above, and the like.

In the case described above, a method of installing the various software programs in the apparatus using an appropriate tool in the stage of manufacture before shipment, the stage of maintenance after the shipment, or the like may be adopted as a method of supplying the various software programs to the hardware described above. A currently general procedure, such as downloading via a communication line such as the Internet may be adopted as the method of supplying the various software programs.

In such a case, it can be considered that the present disclosure is configured with code included in a software program or with a computer-readable recording medium in which the code is recorded. In such a case, such a recording medium is not limited to a medium independent of a hardware apparatus, but includes a storage medium in which a software program transmitted on a LAN, the Internet, or the like is downloaded and stored or temporarily stored.

The data management systems described above may be configured with a virtualization environment in which the hardware apparatuses illustrated in FIG. 34 are virtualized, and various software programs (computer programs) executed in the virtualization environment. In such a case, the components of the hardware apparatuses illustrated in FIG. 34 are provided as virtual devices in the virtualization environment. In this case, the present disclosure can also be implemented in a configuration similar to that in the case of configuring the hardware apparatuses illustrated in FIG. 34 as physical apparatuses.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A data management system comprising a memory and processing circuitry, the processing circuitry being configured to:
divide a table in a database into one or more partitions based on data included in a particular column included in the table;
associate an encryption key with each partition of the partitions and store the encryption key in the memory; and
execute cryptographic processing for data included in the partition by the encryption key being associated with the partition.

2. The data management system according to claim 1, wherein
the processing circuitry is further configured to:
on a basis of a value of first data included in the particular column included in the table, specify the partition including a data set comprising the first data and one or more pieces of second data associated with the first data; and
execute the cryptographic processing for the second data using the encryption key associated with the partition including the data set.

3. The data management system according to claim 2, wherein
the processing circuitry is further configured to:
individually update the encryption key associated with the each partition; and
when updating the encryption key, decrypt the data set included in the partitions, to which the encryption key is associated, by using the encryption key before update, and encrypts the data set again by using the encryption key after update.

4. The data management system according to claim 3, wherein
the processing circuitry is further configured to:
update the encryption key on a basis of an expiration date that is set to the encryption key associated with the each partition.

5. The data management system according to claim 2, wherein
the processing circuitry is further configured to:
be able to re-divide at least one of the partitions further into one or more partitions; and
associates the encryption key, being associated with the partition before re-dividing, with the one or more re-divided partitions, and stores the encryption key in the memory.

6. The data management system according to claim 5, wherein
the processing circuitry is further configured to:
set different expiration dates respectively for the one or more encryption keys associated with the one or more re-divided partitions; and
update the encryption keys according to the expiration date being set.

7. The data management system according to claim 2, wherein
the processing circuitry is further configured to:
be able to accept at least one of a registration request that represents a request for registering a new data set in the table and an acquisition request that represents a request to acquire the data set registered in the table;
when registering the new data set in the table according to the registration request, encrypt at least a portion of the second data in the data set using the encryption key associated with the partition including the data set; and
when acquiring the data set registered in the table according to the acquisition request, decrypt at least a portion of the second data in the data set using the encryption key associated with the partition including the data set.

8. The data management system according to claim 2, wherein
the processing circuitry is further configured to:
according to an encryption level that represents cryptographic strength, associates different encryption keys with the respective partitions, and store the encryption keys in the memory; and
execute cryptographic processing for the data set by using the encryption key according to the encryption level associated with the data set, of the encryption keys associated with the partitions including the data sets.

9. The data management system according to claim 7, wherein
the processing circuitry is further configured to:
according to an encryption level that represents cryptographic strength, associates different encryption keys with the respective partitions, and store the encryption keys in the memory; and
when registering a new data set in the table according to the registration request, encrypts at least a part of the second data included in the registering data set, by using the encryption key according to the encryption level included in the registration request, of the encryption keys associated with the partitions to which the new data set is assigned; and
when acquiring the data set registered in the table according to the acquisition request, decrypt at least a part of the second data included in the acquired data set using the encryption key according to the encryption level included in the data set, of the encryption keys associated with the partitions to which the acquired data set is assigned.

10. The data management system according to claim 7, wherein
the processing circuitry is further configured to
divide the table into the plurality of partitions according to result of dividing a range of data value calculated by executing predetermined operation on the first data;
when registering the data set in the table, specify the partition assigned to which the registering data set is assigned, based on a data value calculated by executing the predetermined arithmetic operation to the first data in the registering data set; and
when acquiring the data set registered in the table, specify the partition to which the registered data set being assigned based on a data value calculated by executing the predetermined arithmetic operation to the first data in the registered data set.

11. The data management system according to claim 10, wherein
the predetermined arithmetic operation is operation for calculating a hash value of the first data; wherein
the processing circuitry further configured to:
equality or substantially equality divides a range of the hash value of the first data, and create the partitions to include respective divided ranges of the hashing value;
when registering the data set in the table, assign the registering data set to the partition including the hash value of the first data in the registering data set; and
when acquiring the data set registered in the table, acquire the registered data set from the partition including the hash value of the first data in the registered data set.

12. The data management system according to claim 11, wherein
the processing circuitry is further configured to:
re-divide particular partition of the partitions, by further equality or substantially equality divide the range of the hashing value included in the particular partition, and create new partitions to include respective newly divided ranges of the hashing value.

13. The data management system according to claim 10, wherein
the database is a key value store (KVS) which stores a pair of a KEY being the first data and a VALUE being at least one or more of the second data, the KEY and the VALUE being associated with each other;
the particular column included in the table is a column including the KEY in the table; and wherein
the processing circuitry is further configured to specify the partition including the data set that includes the KEY as the first data, based on a value of the KEY.

14. The data management system according to claim 9, wherein
the processing circuitry is further configured to:
accept a SQL query, to provide a relational database including at least one relational database table, the encryption level being associated with the relational database table;
convert the SQL query into at least one of the registration request and the acquisition request to the database;
specify the partition including the data set with regard to the registration request and the acquisition request converted from the SQL query, and specify the relational database table indicated by the SQL query; and
execute cryptographic processing for the data set, by using the encryption key according to the encryption level associated with the specified relational database table, of the encryption keys associated with the specified partitions.

15. The data management system according to claim 9,
accept a SQL query, to provide a relational database including at least one relational database table, the encryption level being associated with each column included in the relational database table,
convert the SQL query into at least one of the registration request and the acquisition request to the database;
specify the partition including the data set with regard to the registration request and the acquisition request converted from the SQL query, and specify the column in the relational database table, in which at least a part of the second data included in the data sets is arranged; and
execute cryptographic processing for the data being at least the part of the second data and being arranged in the specified column, by using the encryption key according to the encryption level associated with the specified column, of the encryption keys associated with the specified partitions.

16. The data management system according to claim 9, wherein
the processing circuitry is further configured to:
accept a SQL query, to provide a relational database including at least one relational database table, the relational database table being able to include at least one database partition that is created by logically dividing the the relational database, the encryption level being associated with the database partition;
convert the SQL query into at least one of the registration request and the acquisition request to the database;
specify the partition including the data set with regard to the registration request and the acquisition request converted from the SQL query, and specify the database partition in the relational database table, in which at least a part of the second data included in the data sets is arranged; and
execute cryptographic processing for the data being at least the part of the second data and being arranged in the specified database partition, by using the encryption key according to the encryption level associated with the specified database partition, of the encryption keys associated with the specified partitions.

17. A data management method comprising:
dividing a table in a database into one or more partitions based on data included in a particular column included in the table; and
executing cryptographic processing for data included in the partitions using encryption keys associated with the respective partitions.

18. A non-transitory computer-readable storage medium which is recorded with a computer program, the computer program allowing a computer to execute:
processing of dividing a table in a database into one or more partitions based on data included in a specific column included in the table; and
processing of executing cryptographic processing for data included in the partitions using encryption keys associated with the respective partitions.
